(19) United States
(12) Patent Application Publication
(10) Pub. No.: US 2024/0130432 A1
(43) Pub. Date: Apr. 25, 2024

(54) Method, Computer Program, Power Supply And Aerosol Generating Device For Controlling Communication With One or More Extension Units

(71) Applicant: JT International SA, Geneva (CH)

(72) Inventors: Gabriela Greco Da Fonseca De Carvalho, Chêne-Bourg (CH); Sergei Semashko, Minsk (BY); Raman Rusak, Minsk (BY)

(73) Assignee: JT International SA, Geneva (CH)

(21) Appl. No.: 18/278,114

(22) PCT Filed: Feb. 4, 2022
(86) PCT No.: PCT/EP2022/052704

§ 371 Date: Aug. 20, 2023

(30) Foreign Application Priority Data
Mar. 1, 2021 (EP) 21159904.8

(51) Int. Cl. A24F 40/50; A24F 40/65; G06F 13/42

(52) U.S. Cl. CPC A24F 40/50; A24F 40/65; G06F 13/4282

(57) ABSTRACT

It is provided an extension unit (and correspondingly an aerosol generation device and system) for an aerosol generation device, the extension unit comprising a first connection interface, at a first end of the extension unit, that is connectable to the aerosol generation device. Further, the unit comprises means for enabling at least one additional functionality of the aerosol generation device, further to aerosol generation, when connected to the aerosol generation device.

### CROSS-REFERENCE TO RELATED APPLICATIONS

The present application is a national phase entry under 35 U.S.C. § 371 of International Application No. PCT/EP2022/052704, filed Feb. 4, 2022, published in English, which claims priority to European Application No. 21159904.8, filed Mar. 1, 2021, the disclosures of which are incorporated herein by reference.

### TECHNICAL FIELD

The present invention generally relates to the field of aerosol generation devices. In particular, the present invention is directed to an extension unit for an aerosol generation device, and aerosol generation devices and systems comprising an extension unit.

### BACKGROUND

Aerosol generation devices, such as e-cigarettes, vaping devices and aerosol inhalers, are known. Such aerosol generation devices are hand-held devices and conventionally include an atomizer, a power supply and a liquid-filled capsules or similar means disposed therein in order to generate an aerosol (that is, a vapour) that may be inhaled by the user. The generated aerosol may contain for example, a form of nicotine such that user of the aerosol generation device may, for example, simulate smoking tobacco by inhaling the generated aerosol.

### SUMMARY OF THE INVENTION

### Technical Problem

Aerosol generation devices are subject to a number of inherent limitations. In particular, by way of nonlimiting example, handheld aerosol generation devices generally have to be of a relatively small size and relatively low weight in order to be handheld, normally resulting in limited memory space and power supply, and a simple or minimal user interface.

Currently, there is an ever growing demand for “smart” devices that can provide a wide range of functionalities. The present inventors have recognized that integrating more and more additional hardware into an aerosol generation device in order to provide further functionalities may result in undesirable increases in the size or weight of the device. Furthermore, providing additional software and programs in an aerosol generation device in order to provide additional functionalities may place further burdens on the already limited memory space and power supply of such devices.

Furthermore, there is a demand for electronic devices that can be readily personalized or customized by a user according to the user's tastes and preferences. As such, the present inventors have recognised that providing additional hardware and/or software in an aerosol generation device in order to enable a particular functionality may often be redundant depending on whether or not a user makes use of that particular functionality.

Accordingly, the present inventors have recognized that there is a need to provide a means by which additional functionalities can be provided in an aerosol generation device only as required. Furthermore, the present inventors have recognized that there is a need to provide a means by which functionalities can be added to an aerosol generation device while also ensuring that the device remains of a relatively small size and relatively low weight and without exceeding any limitations of the memory space, power supply and user interface of the aerosol generation device.

### Summary of the Solution

The present invention is intended to address one or more of the above technical problems.

In particular, in view of the limitations discussed above, the present inventors have devised, in accordance with a first example aspect herein, an extension unit. The extension unit comprises a first connection interface, at a first end of the extension unit, that is connectable to the aerosol generation device. The extension unit further comprises means for enabling at least one additional functionality of the aerosol generation device, further to aerosol generation, when connected to the aerosol generation device.

The present inventors have further devised, in accordance with a second example aspect herein, an aerosol generation device comprising a power supply unit. The power supply unit comprises a power supply, a control section, and a connection interface that is connectable to an extension unit in accordance with the first example aspect herein. The control section is configured to control at least one of a magnitude of power supply via the connection interface, direction of power supply by the connection interface and transfer of data via the connection interface.

The present inventors have further devised, in accordance with a third example aspect herein, a system comprising an extension unit in accordance with the first example aspect and an aerosol generation device in accordance with the second example aspect.

The present inventors have further devised, in accordance with a fourth example aspect herein, a method of an aerosol generation device for controlling communication with one or more extension units via a communication bus. Each of the one or more extension units is connectable to the aerosol generation device and configured to enable at least one additional functionality of the aerosol generation device, further to aerosol generation, when connected to the aerosol generation device. The method comprises identifying at least one communication address among a plurality of communication addresses of the communication bus for which signalling is received from an extension unit, among the one or more extension units, using the communication address. The method further comprises associating, with each of the at least one communication address, an extension unit identifier indicating the extension unit from which the signalling was received. The method further comprises determining, for each extension unit identifier, a current connection state of the extension unit indicated by the extension unit identifier. The method further comprises controlling, for each extension unit identifier, communication with the extension unit indicated by the extension unit identifier via the communication bus using the communication address associated with the extension unit identifier and in accordance with the determined current connection state of the extension unit.

The present inventors have further devised, in accordance with a fifth example aspect herein, a computer program comprising instructions which, when executed by a control section of an aerosol generation device, cause the control section to perform the method according to the fourth example aspect herein.

The present inventors have further devised, in accordance with a sixth example aspect herein, an aerosol generation device, comprising a control section configured to perform a method according to the fourth example aspect herein.

The present inventors have further devised, in accordance with a seventh example aspect herein, aerosol generation device comprising a power supply unit according to the sixth example aspect herein.

Accordingly, the first to seventh example aspects allow for one or more extension units to be connected to an aerosol generation device. As each extension unit provides at least one additional functionality beyond the function of aerosol generation provided by the aerosol generation device, it becomes possible to enable one or more additional functionalities in the aerosol generation device.

Furthermore, the first to seventh examples aspects allow additional functionalities provided by the aerosol generation device to be personalized based on user's requirements/needs because the user can select which extension unit to connect to the aerosol generation device. Accordingly, each extension unit can provide additional functionality to enrich the user experience while avoiding that unnecessary hardware and/or software is integrated or pre-installed on a user's aerosol generation device for functionalities that are not relevant to that user.

In addition, in embodiments in which the aerosol generation device can be used with multiple extension units at a time, it is possible to avoid that the user is limited to a single additional functionality at a time. Where extension units have a connection interface at either end, they can be installed on another, thereby providing a kind of “extension unit chain” that allows the user to create his own “setup” and the extension units can be configured in any order relative to the aerosol generation device.

As the control section of the aerosol generation device according to the second example aspect is configured to control at least one of a magnitude of power supply via the connection interface, direction of power supply by the connection interface and transfer of data via the connection interface, it is possible for the aerosol generation device to control the demand placed by the extension unit on the power, memory and other resources of the aerosol generation device.

Furthermore, the method of an aerosol generation device for controlling communication with one or more extension units via a communication bus according to the fourth example aspect allows the aerosol generation device performing said method to simply and efficiently scan through communication addresses of the communication bus in order to identify which addresses are being used for communication by connected extension units and to appropriately control communication with these extension units over the communication bus.

As such, the method according to the fourth example aspect may facilitate provision of a means by which additional functionalities can be provided in an aerosol generation device only as required. Furthermore, the method according to the fourth example aspect may facilitate provision of a means by which functionalities can be added to an aerosol generation device while also ensuring that the device remains of a relatively small size and relatively low weight and without exceeding any limitations of the memory space, power supply and user interface of the aerosol generation device.

### BRIEF DESCRIPTION OF THE DRAWINGS

Embodiments of the invention will now be explained in detail, by way of non-limiting example only, with reference to the accompanying figures, described below. Like reference numerals appearing in different ones of the figures can denote identical or functionally similar elements, unless indicated otherwise.

FIG. 1 is a schematic illustration of an aerosol generation device, according to an example aspect herein.

FIG. 2 is a block diagram illustrating a power supply unit of an aerosol generation device, in accordance with an example aspect herein.

FIG. 3 is a schematic illustration of an extension unit for an aerosol generation device, according to an example aspect herein.

FIG. 4A is a block diagram illustrating a configuration of a “master” device and “slave” devices using I2C communication protocol.

FIG. 4B is a block diagram illustrating a detailed exemplary configuration of a connection between a first device and a second device using I2C communication protocol.

FIG. 4C is a block diagram illustrating a detailed exemplary configuration of a connection between two devices using a serial DART communication protocol.

FIGS. 4D and 4E are block diagrams illustrating two detailed exemplary configurations of a connection between devices using a SPI communication protocol.

FIG. 5 is a schematic illustration showing an exemplary configuration of a power circuit that may be comprised in the power supply unit of FIG. 3 to facilitate integration with external extension units.

FIG. 6A is a schematic illustration of a plurality of extension units and

FIG. 6B is a schematic illustration showing how the extension units may be connected to the aerosol generation device of FIG. 3 to provide an aerosol generation system.

FIG. 7 is a schematic illustration showing an exemplary configuration of a circuit that may be comprised in the extension unit configured according to the first example aspect.

FIG. 8 a schematic illustration showing an exemplary configuration of a circuit 800 that may be comprised in the extension unit 100 configured according to the third example aspect.

FIG. 9 a schematic illustration showing an exemplary configuration of a circuit 900 that may be comprised in the extension unit 100 configured according to the fourth example aspect

FIG. 10 is a block diagram illustrating a layer software architecture suitable for use with the disclosed example aspects.

FIG. 11 is a flow diagram illustrating a process by which the aerosol generation device of FIG. 3 controls communication with one or more extension units via a communication bus, in accordance with an example aspect herein.

FIG. 12 is a flow diagram illustrating an exemplary process by which the aerosol generation device of FIG. 3 may control communication with an extension unit via a communication bus, in accordance with a first example aspect herein.

FIG. 13 is a flow diagram illustrating an exemplary process by which the aerosol generation device of FIG. 3 may control communication with an extension unit via a communication bus, in accordance with a second example aspect herein.

FIG. 14 is a flow diagram illustrating an exemplary process by which the aerosol generation device of FIG. 3 may control communication with an extension unit via a communication bus, in accordance with a third example aspect herein.

FIG. 15 is a flow diagram illustrating an exemplary process by which the aerosol generation device of FIG. 3 may control communication with an extension unit via a communication bus, in accordance with a fourth example aspect herein.

FIG. 16 is a flow diagram illustrating an exemplary process by which the aerosol generation device of FIG. 3 may control communication with an extension unit via a communication bus, in accordance with a fifth example aspect herein.

FIGS. 17A to 17C are flow diagrams illustrating operations performed by the aerosol generation device on the Application Software Layer of the layer software architecture shown in FIG. 10.

FIGS. 18A to 18G are flow diagrams illustrating operations performed by the aerosol generation device on the System Software Layer of the layer software architecture shown in FIG. 10.

FIGS. 19A to 19C are flow diagrams illustrating operations performed by the aerosol generation device on the Board Support Layer of the layer software architecture shown in FIG. 10.

FIGS. 20A to 20C are flow diagrams illustrating operations performed by the aerosol generation device on the Hardware Abstraction Layer of the layer software architecture shown in FIG. 10.

### DETAILED DESCRIPTION

Example embodiments of the present invention will now be described in detail with reference to the accompanying drawings.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

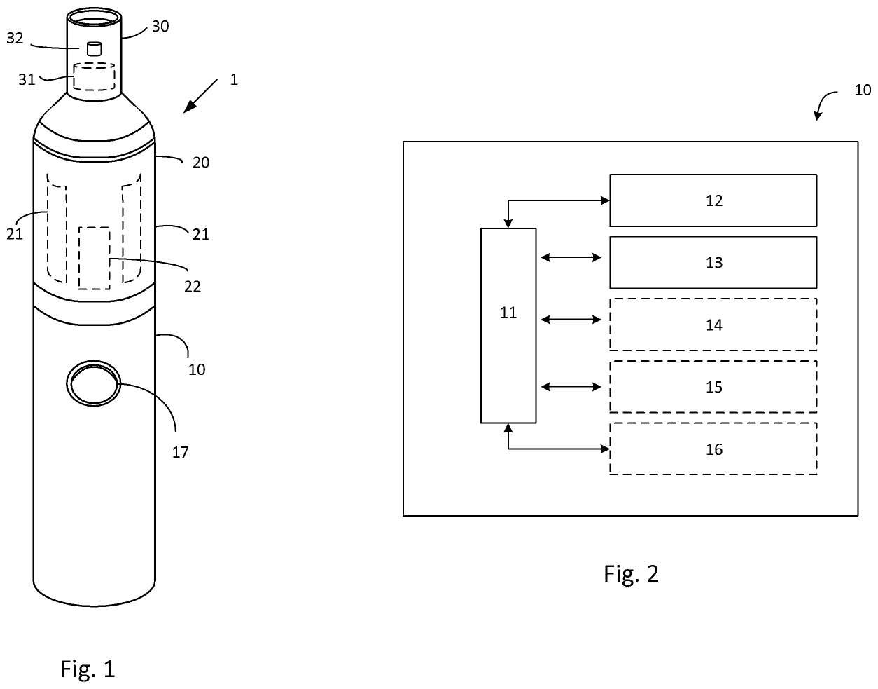

FIG. 1 is a schematic illustration of an aerosol generation device 1, according to an example aspect herein.

The aerosol generation device 1 is a handheld device that is configured to generate an aerosol (that is, a vapour) that may be inhaled by a user of the aerosol generation device 1.

The aerosol generation device 1 may, as in the present example aspect, be a so-called “e-vapour” device. E-Vapor devices contain no tobacco and heat a liquid that contains, by way of non-limiting example, nicotine and/or flavours to create vapor by direct electrical heating of a liquid contained within the device or a replaceable cartridge. In this case, the aerosol generation device 1 may, as in the present example aspect, comprise a power supply unit 10, an aerosol generation unit 20 and optionally, as in the present example aspect, a flavour unit 30.

The aerosol generation unit 20 may, as in the present example, comprise a reservoir 21 for storing an aerosol source and a load 22 for atomizing the aerosol source. Power is provided to the load 22 by the power supply unit 10. A wick or any other suitable means may be provided to draw the aerosol source, which may include a liquid such as glycerin, propylene glycol or water that creates a vapour, from the reservoir 21 to the load 22.

The load 22 atomizes the aerosol source (for example, by heating) thereby generating an aerosol which passes through the flavour unit 30 in response to the inhalation action of the user. In one example, the load 22 is represented by the electrical load of a heating element, i.e. the energy consumed by the heating element. The heating element may be resistive, inductive, etc.

The flavour unit 30 may, as shown in FIG. 1, comprise a flavour source 31 and an inhalation port 32. The flavour source 31 may, for example, contain grains of shredded raw tobacco or another plant (e.g. mint or herbs) and/or flavours such as menthol or fruit flavours such that, a flavour is added to the aerosol as it passes through the flavour source 31.

The power supply unit 10, the aerosol generation unit 20 and the flavour unit 30 may be detachable such that individual units may be readily replaced. By way of example, the elements of the aerosol generation device 1 may be detachably assembled together by any suitable means, e.g. via an interference fit, a snap fit, a screw fit, a bayoneted fit or a magnetic fit between the housings or other portions of the elements. Alternatively, the power supply unit 10, the aerosol generation unit 20 and, optionally, the flavour unit 30 may be fixedly attached such that the various elements cannot be detached, e.g. by ultrasonic welding.

Additionally or alternatively, reservoir 21 and/or the aerosol source stored therein and/or the flavour source 31 may be replaceable. By way of example, at least the reservoir 21 of the aerosol generation unit 20 may be provided in the form of a replaceable cartridge. Additionally or alternatively, the flavour source 31 of the flavour unit 30 may be provided in the form of a replaceable cartridge.

While the aerosol generating unit 20 and the flavour unit 30 of the aerosol generation device 1 of FIG. 1 are shown as separate units, these two units may alternatively be provided as a single unit. By way of further alternative, the aerosol generation device 1 may not comprises a flavour unit. In this case, any flavours may optionally be provided with the aerosol source in the reservoir 21 of the aerosol generation unit 20.

In the example aspect shown in FIG. 1, the aerosol generation device 1 is a so-called “e-vapour” device. Alternatively, the aerosol generation device may be a so-called “T-vapor” device, also commonly referred to as a Heat-not-Burn device or a heated tobacco device. Heat-not-Burn contain tobacco that is heated directly by a heating element (e.g., a tubular heater to surround a tobacco stick) to create vapor. Another type of Heated tobacco device contains tobacco (e.g., tobacco powder in a capsule or pod) which is heated indirectly to create vapor by direct electrical heating of a liquid contained within the device or a replaceable cartridge.

In example aspects in which the aerosol generation device is a “T-vapour” device, the aerosol generation device may comprise a heating oven or other means to heat (but not burn) tobacco provided in the device. The tobacco may, for example, be provided in the form of a tobacco stick similar to traditional stick.

By way of more specific example, in example aspects in which the aerosol generation device is a “T-vapour” device, the power supply unit 10 may comprise, further to a power supply, a heating oven or other means to heat the tobacco, which may be provided in the aerosol generation unit. In this case, the aerosol generation unit may function only to store the tobacco and may not comprise any further electronics.

FIG. 2 is a block diagram illustrating a power supply unit 10 of an aerosol generation device, in accordance with an example aspect herein. The power supply unit 10 may be the power supply unit of the aerosol generation device 1 of FIG. 1. Alternatively, the power supply unit 10 may be the power supply unit of any other suitable aerosol generation device such as, for example, a T-vapour device.

The power supply unit 10 shown in FIG. 2 includes a control section 11, power supply 12, and a connection interface 13. Optionally, the power supply unit 10 may comprise, as in the present example aspect, at least one sensor 14 and/or at least one input/output (I/O) section 15. Furthermore, in the case where the power supply unit 10 is the power supply unit of a T-vapour device, the power supply unit 10 may optionally comprise a heating oven 16 or other means to heat tobacco.

The power supply 12 may, as in the present example, be a rechargeable power supply. The power supply 12 may, as in the present example, be a lithium ion battery. Alternatively, the power supply 12 may be, for example, a chargeable secondary battery or an electric double layer capacitor (EDLC).

The control section 11 may comprise one or more processing units (e.g. a central processing unit (CPU) such as a microprocessor, or a suitably programmed field programmable gate array (FPGA) or application-specific integrated circuit (ASIC)). The control section 11 may, as in the present example aspect, be configured to control operation of the aerosol generation device.

By way of example, the control section 11 may control supply of power to the aerosol generation unit 20 and charging of the power supply 12. Additionally or alternatively, the control section 11 may control supply of power to the at least one sensor 14 as necessary, receive and process signals from the at least one sensor 14, and control operation of the aerosol generation device 1 based on the received signals. Additionally or alternatively, the control section 11 may control output of information to a user of the aerosol generation device 1 by the at least one I/O section 15, reception of user input by the at least one I/O section 15 and control operation of the aerosol generation device 1 based on the received user input. The control section 11 may include separate modules or sections for each function performed.

Additionally or alternatively, the control section 11 may be provided with any memory sections (not shown) necessary to perform its function of controlling operation of the aerosol generation device. Such memory sections may be provided as part of (comprised in) the control section 11 (e.g. integrally formed or provided on the same chip) or provided separately, but electrically connected to the control section 11, within the power supply unit 10. By way of example, the memory sections may comprise both volatile and non-volatile memory resources, including, for example, a working memory (e.g. a random access memory). In addition, the memory sections may include an instruction store (e.g. a ROM in the form of an electrically-erasable programmable read-only memory (EEPROM) or flash memory) storing a computer program comprising the computer-readable instructions which, when executed by the control section 11, cause the control section 11 to perform various functions. The memory sections may further comprise memory resources for storing additional information, such as, for example, information relating to the at least one sensor 14 and at least one input/output (I/O) section 15.

The connection interface 13 may, as in the present example, comprise one or more charging terminals (e.g. USB terminals, micro USB terminals, wireless charging terminals, etc.) for use in charging the power supply 12 and one or more discharging terminals to allow supply of power from the power supply unit 10 to the aerosol generation unit 20 of FIG. 1. The connection interface will be described in further detail below.

In example aspects, such as the present example aspect, in which the power supply unit 10 optionally comprises at least one sensor 14, the at least one sensor 14 may, as in the present example, include an inhalation sensor for use in detecting an inhaling action by a user of the aerosol generation device 1 and/or one or more of voltage and current sensors for use in detecting charging and discharging of the power supply 12.

In example aspects, such as the present example aspect, in which the power supply unit 10 optionally comprises at least one I/O sections 15, the at least one I/O sections 15 may comprise input means for allowing the aerosol generation device 1 to receive input from a user of the aerosol generation device 1. By way of non-limiting example, the power supply unit 10 may comprise a button 17 as shown in FIG. 1. Alternatively, the power supply unit 10 may comprise any suitable input means such as one or more switches or a touch panel, or any suitable combination of such input means. By way of further alternative, the at least one I/O means may not comprise input means and operation of the aerosol generation device 1 may instead be controlled based on the output of the at least one sensor 14.

Additionally or alternatively, the at least one I/O section 15 may comprise output means for supplying information to a user of the aerosol generation device. By way of example, the power supply unit 10 may comprise a display unit such as an LCD screen or a touchscreen. Additionally or alternatively, the power supply unit 10 may comprise one or more LEDs configured to operate according to various lighting patterns in order to provide respective indications (e.g. device powered on, low battery, replacement of aerosol source required) to the user. By way of example, in a case where the power supply unit 10 comprises a single LED, a continuous light may indicate that the aerosol generation device 1 is powered on and a flashing light may indicate low battery (i.e. charging of the power supply 12 is required).

In the exemplary power supply unit 10 shown in FIG. 2, the at least one sensor 14 and the at least one I/O unit 15 are shown separately to the control section 11. Alternatively, one or more of the at least one sensor 14 and/or one or more of the at least one I/O units 15 may be integrated with the control section 11. By way of further alternative, one or more of the at least one sensor 14 may be provided in an aerosol generation unit (such as aerosol generation unit 20 shown in FIG. 1) and appropriate connection terminals may be provided in the power supply unit 10 and the aerosol generation unit in order to allow the output of the sensors in the aerosol generation unit to be provided to the control section 11.

As discussed above, the present inventors have recognised that there is a need to provide a means by which functionalities can be added to an aerosol generation device only as required/needed. Furthermore, the present inventors have recognized that there is a need to provide a means by which functionalities can be added to an aerosol generation device while also ensuring that the device remains of a relatively small size and relatively low weight and without exceeding any limitations of the memory space, power supply and user interface of the aerosol generation device.

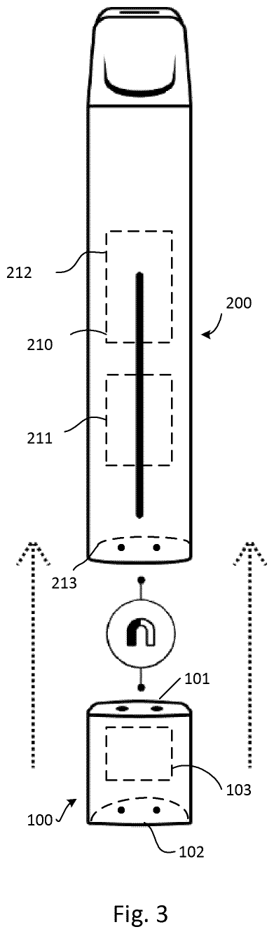

Accordingly, the present inventors have devised an extension unit 100 for an aerosol generation device 200, according to an example aspect herein, as shown in FIG. 3.

The extension unit 100 comprises a first connection interface 101, at a first end of the extension unit, the first connection interface 101 being connectable to the aerosol generation device and means 103 for enabling at least one additional functionality of the aerosol generation device 200, further to aerosol generation, when the extension unit 100 is connected to the aerosol generation device 200.

Optionally, the extension unit 100 may, as in the present example aspect, comprise a second connection interface 102. In alternative example aspects, the extension unit may comprise the first connection interface 101 only.

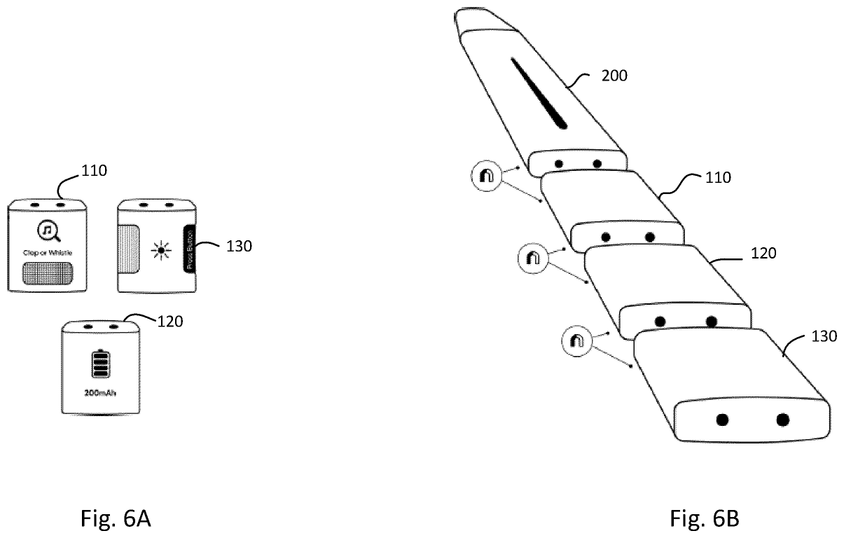

As shown in FIG. 3, the first connection interface 101 may be provided at the first end of the extension unit 100. The first connection interface 101 may, as in the present example aspect, be connectable to a first other extension unit (such as extension units 110 and 120 shown in FIG. 6B).

In addition, the optional second connection interface 102 may, as shown in FIG. 3, by provided at a second end of the extension unit 100 opposite to the first end and may be connectable to a second other extension unit (such as extension units 110 and 120 shown in FIG. 6B).

In the example aspect shown in FIG. 3, the first connection interface 101 is connectable to the aerosol generation device 200. Optionally, the second connection interface 102 may also be connectable to the aerosol generation device 200, such that both of the first connection interface 101 and the second connection interface 102 may be connectable to the aerosol generation device 200. In this case, either end of the extension unit 100 can be connected to the aerosol generation device 200 and the connected extension unit 100 may provide the at least one additional functionality to the aerosol generation device 200 regardless of its orientation relative thereto.

The first connection interface 101 and/or the second connection interface 102 may be connectable to other extension units and/or the aerosol generation device 200 by any suitable means, e.g. via an interference fit, a snap fit, a screw fit, a bayoneted fit or a magnetic fit between the housings or any other suitable portions of these elements. That is, first connection interface 101 and/or the second connection interface 102 may comprise any suitable means necessary to facilitate a physical (i.e. mechanical) connection to the aerosol generation device 200. By way of example, in order to facilitate connection to other extension units and/or the aerosol generation device 200, the first connection interface 101 and/or the second connection interface 102 may comprise at least one of a magnetic connector, an interference fit connector, a plug connector, and a socket connector connectable to the aerosol generation device or the first other extension unit. In the example aspect shown in FIG. 3, the first connection interface 101 comprises a magnetic connector.

The extension unit 100 may be configured to receive power supplied from the aerosol generation device 200, e.g. via the first connection interface 101. Alternatively, in example aspects such as the present example aspect in which the extension unit 100 comprises the optional second connection interface 102, the extension unit 100 may be configured to receive power supplied from the aerosol generation device 200 via one of the first connection interface 101 and the second connection interface 102, when the one of the first connection interface 101 and the second connection interface 102 is connected to the aerosol generation device 200.

Additionally or alternatively, the extension unit 100 may be configured to supply power to the aerosol generation device 200 via the first connection interface 101. Alternatively, in example aspects such as the present example aspect in which the extension unit 100 comprises the optional second connection interface 102, the extension unit 100 may be configured to supply power to the aerosol generation device 200 via one of the first connection interface 101 and the second connection interface 102, when the one of the first connection interface 101 and the second connection interface 102 is connected to the aerosol generation device 200, depending on the means 103 provided as part of the extension unit 100.

Furthermore, the extension unit 100 may be configured to receive data from or transmit data to the aerosol generation device 200 via the first connection interface 101. Alternatively, in example aspects such as the present example aspect in which the extension unit 100 comprises the optional second connection interface 102, the extension unit 100 may additionally or alternatively be configured to receive data from or transmit data to the aerosol generation device 200 via the first connection interface 101 and/or the second connection interface 102 when that connection interface is connected to the aerosol generation device 200. That may include, for example, commands, instructions or feedback and may be provided in any suitable form such as, for example, a signal having a variable current or voltage.

The first connection interface 101 and/or the second connection interface 102 may comprise any suitable means necessary to facilitate an electronic connection to other extension units and/or the aerosol generation device 200. For example, the first connection interface 101 and/or the second connection interface 102 may comprise any suitable means for facilitating an electronic connection via the connection interface 213 of the aerosol generation device 200 to the control section 211 and/or the power supply 212 of the aerosol generation device 200 and/or any suitable means for facilitating an electronic connection via a connection interface of another extension unit.

By way of example, at least one of the first connection interface 101 and the second connection interface 102 may comprise one or more data terminals and/or one or more power terminals. Preferably, the first and/or second connection interfaces may include inter-integrated circuit, I2C, interfaces.

By way of example, the first connection interface 101 may comprise one or more power terminals. At least one of a magnitude of power supply and a direction of power supply by the first connection interface 101 may controlled by the aerosol generation device 200, when the extension unit 100 is connected to the aerosol generation device 200. Additionally or alternatively, in example aspects such as the present example aspect, in which the extension unit 100 comprises the optional second connection interface 102, the second connection interface 102 may comprise one or more power terminals. At least one of a magnitude of power supply and a direction of power supply by the second connection interface 102 may controlled by the aerosol generation device 200, when the extension unit 100 is connected to the aerosol generation device 200. In this way, supply of power from the extension unit 100 to the aerosol generation device 200 and/or vice versa may be performed under the control of the aerosol generation device 200, via the first connection interface 101 and/or the second connection interface 102.

The present inventors have recognised that Inter-Integrated Circuit (I2C) may be the most suitable hardware protocol for communication between the extension unit 100 and the aerosol generation device 200 and/or other extension units. By way of alternative, other protocols for communication may be used such as Serial Peripheral Interface (SPI) and Asynchronous Serial Interfaces (such as RS-232 or universal asynchronous receiver/transmitters, UARTs). However, use of I2C may provide further additional advantages, as described below.

I2C is a protocol intended to enable multiple “slave” digital integrated circuits (“chips”) to communicate with one or more “master” chips. Like the SPI, it is designed only for short distance communications within a single device. Like Asynchronous Serial Interfaces (such as RS-232 or UARTs), it requires two signal wires to exchange information.

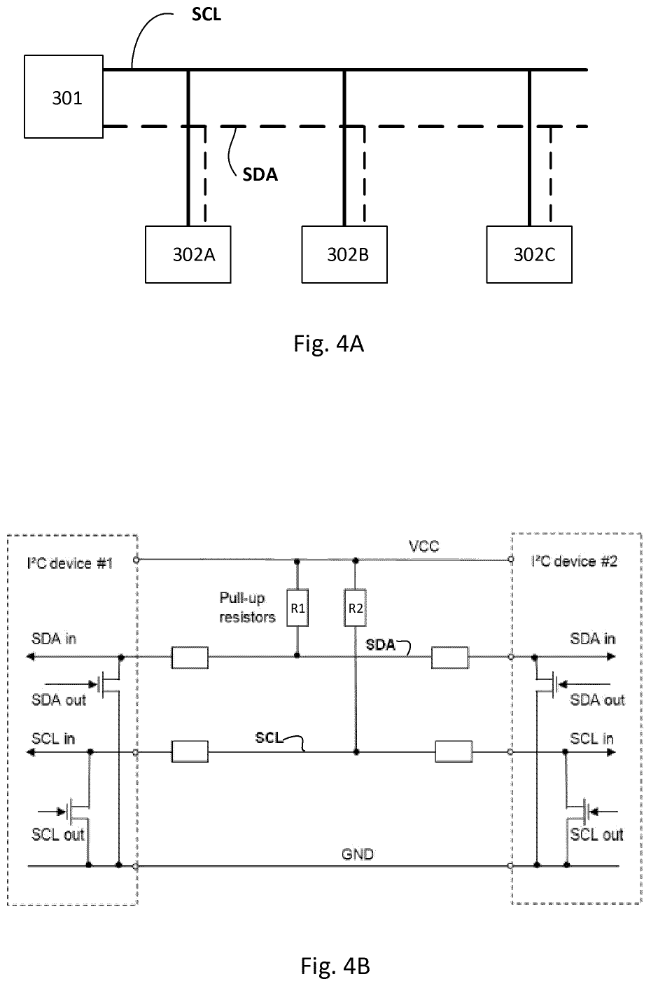

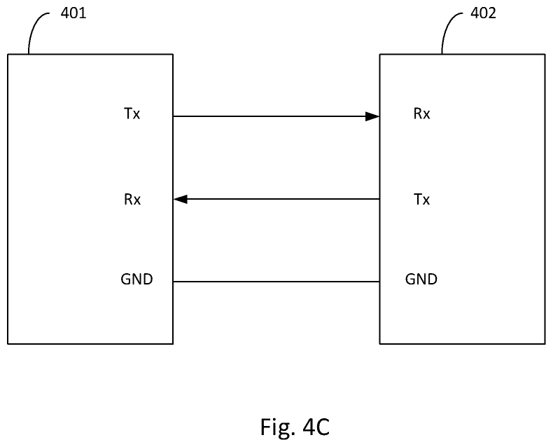

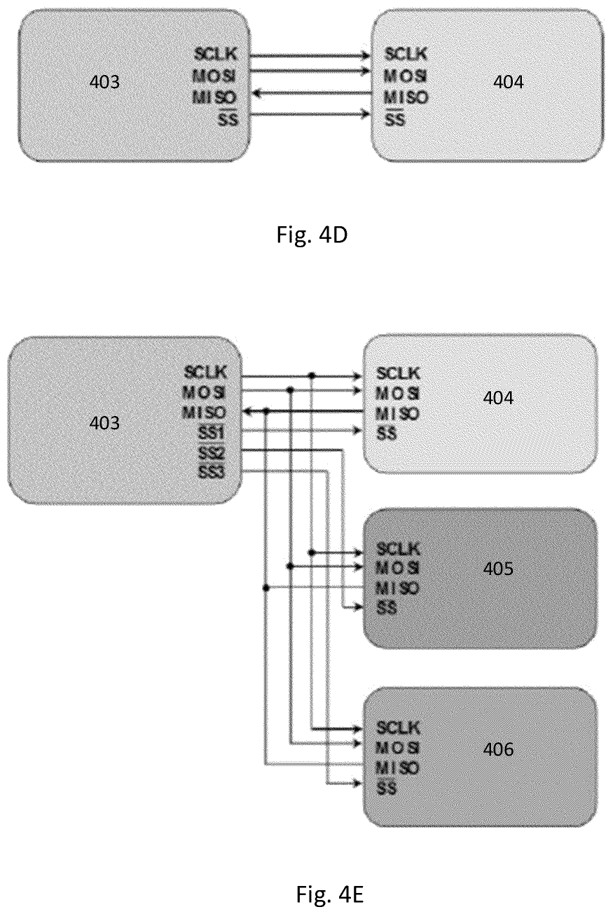

FIG. 4A is a block diagram illustrating a configuration of a “master” device 301 and “slave” devices 302A, 302B, 302C using I2C communication protocol. FIG. 4B is a block diagram illustrating a detailed exemplary configuration of a connection between a first device and a second device using I2C communication protocol. In the present example, “master” device is the aerosol generation device and “slave” devices are extension units connectable to the aerosol generation device.

As shown in FIGS. 4A and 4B, the I2C bus consists of two signals: SCL and SDA. SCL is the clock signal, and SDA is the data signal. The current bus master 301 always generates the clock signal; some slave devices 302A, 302B, 302C may force the clock low at times to delay the master device 301 sending more data (or to require more time to prepare data before the master device 301 attempts to clock it out). It is called “clock stretching”. Unlike UART or SPI connections, the I2C bus drivers are “open drain,” meaning that they can pull the corresponding signal line low, but cannot drive it high. Thus, there can be no bus contention where one device is trying to drive the line high while another tries to pull it low, eliminating the potential for damage to the drivers or excessive power dissipation in the system. Each signal line has a pull-up resistor R1, R2 (as shown in FIG. 4B) to restore the signal to high when no device is asserting it low. Resistor selection varies with devices on the bus.

I2C addresses are either 7 bits or 10 bits. The use of 10-bit addresses is comparatively rare such that standard chips generally use have 7-bit addresses. As such, up to 128 devices may be accommodated on the I2C bus, even when a standard is used, since a 7-bit number can be from 0 to 127. When sending a 7-bit address, a device may be configured to send 8 bits, wherein the extra bit is used to inform the address slave device if the master device is writing to it or reading from it. In particular, where the extra bit has a value of 0, this may indicate that the master device is writing to the addressed slave device. Similarly, where the extra bit has a value of 1, this may indicate that the master device is reading from the addressed slave device. By way of example, the 7-bit address may be located in the byte's upper 7 bits, and the Read/Write (R/W) bit is in the LSB (Least Significant Bit). In cases where 10-bit addresses are used, an extra bit may be used to indicate whether the master device is writing to or reading from the addressed slave device in a corresponding manner.

FIG. 4C is a block diagram illustrating a detailed exemplary configuration of a connection between two devices 401, 402 using a serial UART communication protocol. Since serial ports are asynchronous (no clock data is transmitted), devices 401, 402 using them must agree ahead of time on a data rate. The two devices 401, 402 must also have clocks close to the same rate: excessive differences between clock rates on either end will cause garbled data.

Asynchronous serial ports require hardware overhead: the UART at either end is relatively complex and challenging to implement in software accurately. At least one start and the stop bits are the part of each data frame. Thereby, sending 8 bits of data requires 10 bits of transmission time.

Furthermore, asynchronous serial ports are inherently suited to communications between only two devices. While it is possible to connect multiple devices to a single serial port, bus contention (where two devices attempt to drive the same line simultaneously) is always an issue. It must be handled carefully, usually through external hardware, to prevent damage to the devices.

FIGS. 4D and 4E are block diagrams illustrating two detailed exemplary configurations of a connection between devices using a SPI communication protocol.

Compared to serial UART and I2C, SPI requires a relatively high number of pins. As shown in FIG. 4D, connecting a single master device 403 to a single slave device 404 with an SPI bus requires four lines. Furthermore, as shown in FIG. 4E, each new slave device 405, 406 requires one additional chip select I/O pin on the master device 403, resulting in a rapid proliferation of pin connections as new slave devices 405, 406 when lots of devices must be slaved to a single master device 403.

Also, the large number of connections for each device can make routing signals more difficult in tight PCB layout situations. SPI only allows one master device 403 on the bus but does support an arbitrary number of slave devices 404, 405, 406 (subject only to the drive capability of the devices connected to the bus and the number of chip select pins available).

SPI is suitable for high data rate full-duplex (simultaneous sending and receiving of data) connections, supporting clock rates upwards of 10 MHz (and thus, 10 million bits per second) for some devices, and the speed scales well. The hardware at either end is usually a very simple shift register, allowing easy implementation in software.

Accordingly, use of the I2C communication protocol may be advantageous in that it requires a mere two wires, like asynchronous serial protocols. In contrast, the SPI communication protocol requires a significant amount of additional wiring between each device.

Also, unlike the SPI communication protocol, the I2C communication protocol can support a multi-master system, allowing more than one master device to communicate with all devices on the bus (although the master devices can't talk to each other over the bus and must take turns using the bus lines).

Data rates achieved by use of the I2C communication protocol fall between those achieved by asynchronous serial and SPI protocols. In particular, most I2C devices can communicate at 100 kHz or 400 kHz. There is an overhead with I2C: for every 8 bits of data, one extra bit of metadata (the “ACK/NACK” bit) is transmitted.

Although the hardware required to implement the I2C communication protocol is more complex than for the SPI communication protocol, it is considerably less complex than that required to implement asynchronous serial protocols. Furthermore, the hardware required to implement the I2C communication protocol can be relatively trivially implemented in software.

Accordingly, I2C may be a particularly advantageous choice of protocol for implementing communication between the extension unit 100 and the aerosol generation device 200 and/or other extension units. In particular, the ability to connect up to 127 devices with only two communication lines (SDA/SCL) allows multiple extension units to be connected to a single aerosol generation device without causing undue increase in the required amount of wiring. Furthermore, most digital sensors and devices support the I2C protocol. As such, a fairly high data transfer rate (up to 1 MHz) allows implementing various high-load data acquisition systems.

Turning back to FIG. 3, the extension unit 100 further comprises the means 103 for enabling at least one additional functionality of the aerosol generation device 200, further to aerosol generation, when the extension unit 100 is connected to the aerosol generation device 200.

The at least one additional functionality may be an electrical or electronic functionality, i.e. a functionality obtained based on electric power. By way of example, the means 103 may be configured to be electronically connected to the aerosol generation device 200 (e.g. to the control section 211 or power supply 212 of the power supply unit 210) via one of the first connection interface 101 and the second connection interface 102 when the extension unit 101 is connected to the aerosol generation device 200. In particular, the means 103 may be configured to enable the at least one additional functionality based on transfer of power and/or data between the extension unit 100 and the aerosol generation device 200.

Additionally or alternatively, the at least one functionality may be further or supplemental to the function of aerosol generation provided by the aerosol generation device 200 (e.g. by power supply unit 10, aerosol generation unit 20 and optionally flavour unit 30) in that the at least one functionality does not influence or affect the generation of aerosol by aerosol generation device 200. That is, the at least one additional functionality may distinct to functionalities for aerosol generation, such as the addition of a flavour to a generated aerosol.

By way of example, the at least one additional functionality may include, for example, one or more of:
a flashlight functionality;
a haptic feedback functionality for indicating a status of the aerosol generation device;
a power supply functionality of supplying power via the first connection interface and/or the second connection interface to a connected device;
a display functionality; and
an audio output functionality.

The means 103 are dependent on the at least one additional functionality to be enabled by the extension unit 100. Examples of means 103 for various additional functionalities are described in detail below.

By way of example, it may be advantageous to ensure that the combination of the aerosol generation device 200 and any connected extension units 100 remain of a relatively small size and relatively low weight, such that the aerosol generation device 200 may be easily and conveniently handled and used for generating aerosol to be inhaled by a user, even while the extension units are attached.

In this case, it may be preferable that each extension unit provides a minimal number of additional functionalities (e.g. only one functionality, or up to two or three functionalities), such that the number of components in and, as such, the size and weight of each extension unit 100 may be kept to a minimum. As such, the extension unit 100 may be distinct from mobile communication devices (such as smart phones, mobile phones, tablets, laptop computers, etc.), which provide large numbers of electrical or electronic functionalities but are relatively large in size and relatively heavy (e.g. in comparison to an aerosol generation device). In particular, use of the aerosol generation device 200 while connected to one or more mobile communication devices may be unwieldy and impractical. That is, the extension unit 100 may not be a mobile communication device.

Additionally or alternatively, in this case, it may be preferable that the physical connection provided by the first and/or the second connection interface 101, 102 of the extension unit 100 to the aerosol generation device 200 may be configured such that the extension unit 100 may be integrated with the body of the aerosol generation device 200 when attached to the aerosol generation unit 200 such that the aerosol generation device 200 and extension unit 100 may be used and handled together as a single unit.

The aerosol generation device 200 may, as in the present example aspect, be the aerosol generation device 1 shown in FIG. 1 or any of the alternative aerosol generation devices described in relation to FIG. 1. Accordingly, the above descriptions of aerosol generation devices applies mutatis mutandis to aerosol generation device 200.

More particularly, aerosol generation device 200 may comprise a power supply unit 210. The power supply unit 210 may be as described above in relation to the power supply unit 10 of FIG. 2. The power supply unit 210 may comprise a control section 211, a power supply 212 and connection interface 213. The description of the control section 11, power supply 12 and connection interface 13 of power supply unit 10 of FIG. 2 applies equally to control section 211, power supply 212 and connection interface 213 and, as such, will not be repeated here.

The connection interface 213 may be connectable to the extension unit 100. By way of example, the connection interface 213 may be connectable to the extension unit 100 by any suitable means, e.g. via an interference fit, a snap fit, a screw fit, a bayoneted fit or a magnetic fit between the housings or any other suitable portions of these elements.

More generally, the connection interface 213 may be provided with any suitable connecting means such that the connection interface 213 of the aerosol generation device 200 is compatible with the first connection interface 101 or the second connection interface 102 of the extension unit 100. By way of example, in order to facilitate connection to the extension unit 100, the connection interface 213 may comprise at least one of a magnetic connector, an interference fit connector, a plug connector, and a socket connector connectable to the extension unit 100. In the example aspect shown in FIG. 3, the connection interface 213 comprises a magnetic connector compatible with the magnetic connector of the first connection interface 101 of the extension unit 100.

The control section 211 may be configured to control at least one of a magnitude of power supply via the connection interface 213, a direction of power supply by the connection interface 213 and transfer of data via the connection interface 213.

By way of example, the aerosol generation device 200 may be configured to supply power via the connection interface 213, when the extension unit 100 is connected to the connection interface 213 of the aerosol generation device 200. Additionally or alternatively, the aerosol generation device 200 may be configured to receive power supplied from the extension unit 100 via the connection interface 213, when the extension unit 100 is connected to the connection interface 213 of the aerosol generation device 200, depending on the means 103 provided as part of the extension unit 100.

In order facilitate the supply of power via the connection interface 213 to an extension unit and, optionally, receiving of power supplied from a suitably configured extension unit, the power supply unit 210 of the aerosol generation device 200 may comprise a number of additional elements. By way of example, the power supply unit 210 may comprise one or more of a fuel gauge, a battery charger, a supply translating transceiver, a boost DC/DC converter and power supply management logic. One or more of these elements may be provided as part of the control section 211 of the power supply unit 210.

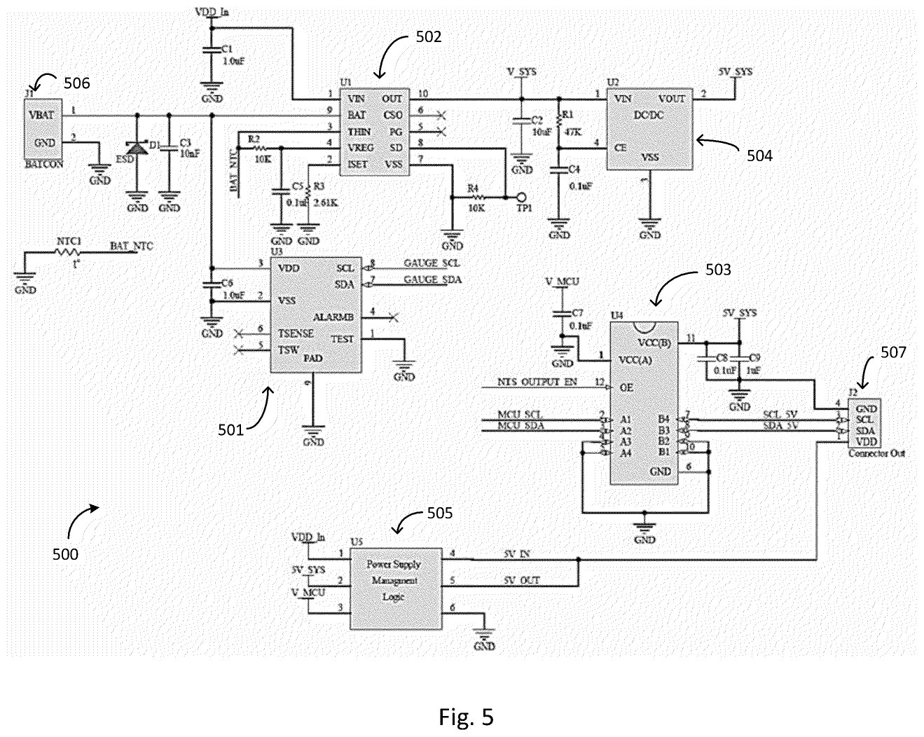

By way of example, FIG. 5 is a schematic illustration showing an exemplary configuration of a power circuit 500 that may be comprised in the power supply unit 210 of FIG. 3 to facilitate integration with external extension units.

The power circuit 500 shown in FIG. 5 comprises a fuel gauge 501, a battery charger 502, a supply translating transceiver 503, a boost DC/DC converter 504, and power supply management logic 505, as well as battery 506 which serves as the power supply 202 of the power supply unit 210 of FIG. 3 and an external connector 507 which serves as the connection interface 213. One or more of elements 501 to 505 may be provided as part of the control section 211 of the power supply unit 210.

The primary function of the power circuit 500 is to control supply of power and its direction through the external connector 507, alongside forming reference voltages on the aerosol generation device 200 itself and providing the ability to charge the battery 506.

The fuel gauge 501 functions to perform battery level measurements to support the at least one additional functionality provided by extension units such as extension unit 100.

Fuel gauge 501 may be configured to measure the remaining power level of the battery 506 used for portable devices. The fuel gauge 501 may be configured to reduce fuel gauge errors with a correction technology during the measurement of battery temperature and voltage. The fuel gauge 501 may have high precision thereby reducing or avoiding entirely the need for external sense equipment or similar means.

The battery charger 502 may be a linear charger IC for single-cell lithium-ion batteries and lithium polymer batteries. The path function may be advantageously configured to give system power supply priority over charging the lithium-ion battery. The charge current can be adjusted with external resistance.

The supply translating transceiver 503 may advantageously used in order to facilitate interfacing between the aerosol generation device 200 and extension units such as extension unit 100 operating at different supply voltages. By way of example, the supply translating transceiver 503 may enable bidirectional voltage level translation. By way of further example, in a case where an I2C communication protocol is used, one or more components of the power supply circuit 500 may operate at a first supply voltage, V_MCU, and the I2C lines may operate at a second supply voltage of, for example, 5V.

The boost DC/DC converter 504 is a power converter that steps up the voltage from its input to its output. As such, in cases where one or more components of the power supply circuit 500 operate at a first supply voltage and the I2C lines operate at a second supply voltage of, for example, 5V, the boost DC/DC converter to raise the voltage available from the battery to 5V as a universal power supply for various ICs.

The power supply management logic 505 may implement various power supply circuits and power direction control. One of its primary functions is to control the power supply direction through the VDD port of the external connector 507.

By way of example, the aerosol generation device 200 may be configured to supply the external connector 507 with a voltage of 5V to power it up and read its address via the I2C bus when connecting an extension unit such as extension unit 100. In case where the connected extension unit is configured to supply power to the aerosol generation device 200, power supply management logic 505 must switch the direction of power supply of this port 507 from output to input for further charging of the battery 506.

Turning back to FIG. 3, the aerosol generation device 200 may additionally or alternatively be configured to receive data from or transmit data to the extension unit 100 via the connection interface 213 when the connection interface 213 is connected to the extension unit 100. That may include, for example, commands, instructions or feedback and may be provided in any suitable form such as, for example, a signal having a variable current or voltage.

The connection interface 213 may comprise any suitable means necessary to facilitate an electronic connection to the extension unit 100. For example, the connection interface 213 may comprise any suitable means for facilitating an electronic connection via the first connection interface 101 or the second connection interface 102 of the extension unit 100. By way of example, the connection interface 213 may comprise one or more data terminals and/or one or more power terminals. Preferably, the connection interface 213 may include an inter-integrated circuit, I2C, interface as described above in relation to the extension unit 100.

As is clear from the preceding description, the configuration of extension unit 100 and aerosol generation device 200 allow one or, optionally, more extension units (including extension unit 100 and/or at least one correspondingly configured extension units) to be connected to the aerosol generation device 200 in order to provide an aerosol generation system.

By way of example, FIG. 6A is a schematic illustration of a plurality of extension units 110, 120, 130 and FIG. 6B is a schematic illustration showing how the extension units 110, 120, 130 may be connected to the aerosol generation device 200 to provide an aerosol generation system. The aerosol generation device 200 is that of FIG. 3. The description of extension unit 100 of FIG. 3 applies equally to extension units 110, 120, 130.

In the example aspect of FIG. 6A, extension unit 110 comprises means for enabling a flashlight functionality when the extension unit 110 is connected to the aerosol generation device 200; the extension unit 120 comprises means for enabling a power supply functionality of supplying power via the first connection interface and/or the second connection interface to the aerosol generation device 200 and/or another connected device when the extension unit 120 is connected to the aerosol generation device 200; and the extension unit 130 comprises means for enabling an audio output function when the extension unit 130 is connected to the aerosol generation device 200.

As shown in FIG. 6B, extension units 110, 120, 130 may be connected in series to the aerosol generation device 200 to provide an aerosol generation system. By way of example, one of the first connection interface and the second connection interface of the extension unit 110 may be connected to the connection interface 213 of the power supply unit 210 of the aerosol generation device 200.

In the example aspect shown in FIG. 6B, one of the first connection interface and the second connection interface of the extension unit 120 is connected to the other of the first connection interface and the second connection interface of the extension unit 110. Furthermore, one of the first connection interface and the second connection interface of the extension unit 130 is connected to the other of the first connection interface and the second connection interface of the extension unit 120.

In the example aspect shown in FIG. 6B the extension units 110, 120, 130 are connected such that the extension unit 110 is closest to the aerosol generation device 200 and the extension unit 130 is furthest from the aerosol generation device 200. Alternatively, the extension units 110, 120, 130 may be connected to the aerosol generation device 200 in any order. By way of further alternative, fewer or more extension units may be connected to the aerosol generation device 200 than in the example aspect shown in FIG. 6B.

In the example aspect of FIG. 6A, each of the extension units 110, 120 and 130 comprise an optional second connection interface. In alternative example aspects in which each extension unit 110, 120 and 130 comprises the first connection interface 101 only and do not comprise such an optional second connection interface, a single extension unit among extension units 110, 120 and 130 may be connected at any given time to the aerosol generation device 200 in order to provide an aerosol generation system. In this case, the user of the aerosol generation device 200 may swap the connected extension unit among extension units 100, 120 and 130 depending on the at least one additional functionality required by the user.

Accordingly, as each extension unit 110, 120, 130 provides at least one additional functionality beyond the function of aerosol generation provided by the aerosol generation device 200, it becomes possible to enable one or more additional functionalities in the aerosol generation device 200 by connecting one or more extension units 110, 120, 130.

Furthermore, the additional functionalities to be provided by the aerosol generation device 200 may be personalized based on user's requirements/needs. Accordingly, each extension unit 110, 120, 130 can provide additional functionality to enrich the user experience while avoiding that unnecessary hardware and/or software is integrated or pre-installed on the aerosol generation device 200 for functionalities that are not relevant to that user.

Furthermore, in example aspects such as the example aspect of FIGS. 6A and 6B in which the aerosol generation device 200 can be used with multiple extension units 110, 120, 130 at a time, it is possible to avoid that the user is limited to a single additional functionality at a time. Since extension units 110, 120, 130 have a connection interface at either end, they can be installed on another, thereby providing a kind of “extension unit chain” that allows the user to create his own “setup” and the extension units 110, 120, 130 can be configured in any order relative to the aerosol generation device.

Furthermore, as the control section 210 of the aerosol generation device 200 is configured to control at least one of a magnitude of power supply via the connection interface 213, direction of power supply by the connection interface 213 and transfer of data via the connection interface 213, it is possible for the aerosol generation device 200 to control the demand places by the extension units 110, 120, 130 on the power, memory and other resources of the aerosol generation device 200.

Examples of means 103 of the extension unit 100 for various additional functionalities are now described in detail.

As a first example aspect, the at least one additional functionality of the extension unit 101 may comprise a flashlight functionality.

The flashlight functionality is a functionality of emitting light or providing additional light when required, for example in response to input from the user. A flashlight is a useful tool that may be advantageously integrated into electronic handheld devices, such as aerosol generation devices, besides their primary functionality. Provision of an additional flashlight functionality by connecting of a suitably configured extension unit to an aerosol generation device may be particularly practical in that the user often has the aerosol generation device on their person so as to be readily available when additional light is required. Accordingly, an extension unit 100 configured to provide a flashlight functionality may provide the advantages of being easily accessible and simple to use.

In the present example aspect, the means 103 for enabling the at least one additional functionality may comprise at least one LED. Alternatively, the means 103 may comprise any other suitable means of emitting light.

In order to operate correctly, a flashlight must be controlled and powered. By way of example, the extension unit 100 of the first example aspect may rely on the aerosol generation device 200 in terms of control and power supply.

By way of example, the at least one LED may be configured to emit light and/or to blink or dim the emitted light in response to control signalling received from the aerosol generation device 200, for example via the first connection interface 101 and/or the second connection interface 102 (in example aspects in which the extension unit 100 comprises an optional second connection interface). By relying on the aerosol generation device 200 in terms of control and power supply, the extension unit 100 of the first example aspect may be cheap and simple to manufacture.

Accordingly, the means 103 may optionally include any elements necessary to enable the extension unit 100 having a flashlight functionality to be power and controlled. By way of example, the means 103 for enabling the flashlight functionality may comprise further elements, including, for example, at least one of a GPIO expander, a DC/DC converter, a MOSFET or any other suitable transistor, and one or more of resistors and capacitors.

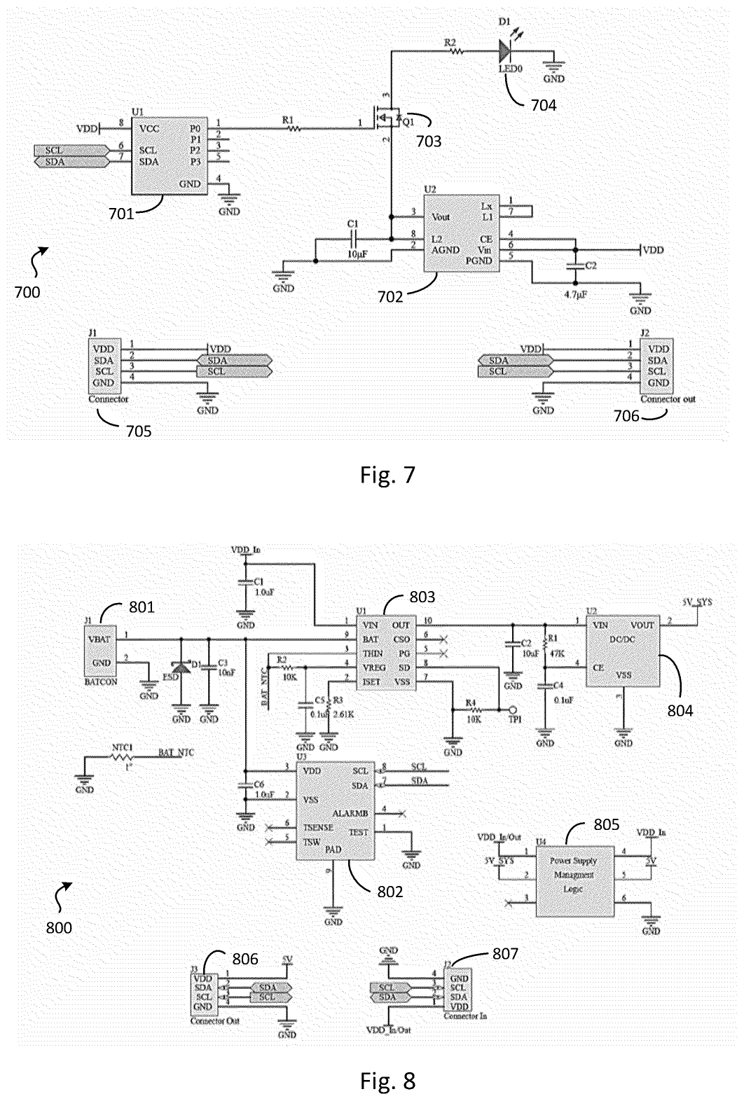

FIG. 7 is a schematic illustration showing an exemplary configuration of a circuit 700 that may be comprised in the extension unit 100 configured according to the first example aspect.

The circuit 700 comprises a GPIO expander 701, a DC/DC converter 702, a MOSFET 703, an LED 704, two resistors R1, R2 and two capacitors C1, C2, as well as two external connectors 705, 706. The first connection interface 101 and the second connection interface 102 of the extension unit 100 are implemented by external connectors 705, 706 and the description of the external connector 507 of FIG. 5 applies mutatis mutandis to external connectors 705, 706.

Regarding control, control signals may be provided from the aerosol generation device 200 via an I2C bus, such as that described in relation to FIGS. 4A, 4B and 5, or via any other suitable communication means. Control signals may, for example, cause the extension unit 100 to turn the light on and off.

The GPIO expander 701 serves the purpose of converting logical data from the I2C bus to the physical state of GPIO expander 701. Accordingly, when the extension unit 100 according to the first example aspect is connected to the aerosol generation device 200, the aerosol generation device 200 can directly control the LED state via the available interface. The GPIO expander 701 may controlled via the I2C bus in order to convert the logical signal from I2C to physical one.

In examples such as the circuit shown in FIG. 7 in which an I2C bus is used, the 5V power supply line that can be used as a power source for the extension unit 100 according to the first example aspect. As many LEDs commonly use 3-3.3V power to operate, it is necessary to step the voltage down using DC/DC converter 702 where such a 5V power supply is used.

The MOSFET 703 is provided in order to prevent current from being drawn directly from the GPIO expander. The MOSFET 703 is further used to control the current flow from the DC-DC converter 702.

The LED 704 may be selected between a high power LED and a low power LED, being of lower power than the high power LED. The high power LED provides a brighter emitted light but drawing a higher current which may impact battery life of the aerosol generation device 200. The low power LED provides a less bright emitted light than a high power LED, but requires less current and, as such, a substantially lower impact on battery life of the aerosol generation device 200. By way of example, a lower power LED can be turned on for hours.

As both approaches may be useful in different cases, the circuit 700 is configured so as to be compatible with both a low power LED and a high power LED. With the power circuit 700 of FIG. 7, it is only necessary to change LED 704 and resistor R2 to balance brightness and battery life if the current for LED is no more than 500 mA.

The circuit 700 of FIG. 7 further comprises two resistors R1, R2 and two capacitors C1, C2. The resistors R1, R2 serve to limit current flow, thereby preventing that the LED 704 overheats and malfunctions. The resistance of resistors R1 and R2 is dependent on the power and the current drawn by the LED 704.

As a second example aspect, the at least one additional functionality may comprise a haptic feedback functionality for indicating a status of the aerosol generation device. In this case, the means 103 for enabling the at least one additional functionality may, for example, comprise at least one of an eccentric rotating mass, ERM, vibration motor and a linear resonant actuator, LRA, vibration motor to generate haptic feedback in the form of vibrations.

In such extension units in which the means 103 comprises at least one of an ERM vibration motor and a LRA vibration motor, the means 103 may be configured to generate haptic feedback in response to control signalling received from the aerosol generation device 200, for example via the first connection interface 101 and/or the second connection interface 102 of the extension unit 100 (in example aspects in which the extension unit 100 comprises an optional second connection interface). By way of example, the extension unit 100 according to the second example aspect may be configured to receive control signalling using any of the communication protocols described above in relation to FIG. 3.

Additionally or alternatively, the extension unit 100 according to the second example aspect may be controlled to provide haptic feedback to user indicative of a state of the aerosol generation device 200. For example, the extension unit 100 of the second example aspect may be configured, when connected to the aerosol generation device 200, to provide haptic feedback indicative of a low battery state of the aerosol generation device 200 or any other warning notification.

As a third example aspect, the at least one additional functionality may comprise a power supply functionality of supplying power to a connected device.

By way of example, the extension unit 100 of the third example aspect may be configured to supply power to the connected device via the first connection interface 101. Alternatively, in example aspects in which the extension unit 100 comprises a second connection interface, the extension unit 100 of the third example aspect may be configured to supply power to the connected device via the first connection interface 101 and/or the second connection interface 102.

The connected device may, as in the present example aspect, comprise the aerosol generation device 200. As a portable handheld device, aerosol generation devices such as aerosol generation device 200, have a limited battery life. By providing an extension unit 100 with a power supply functionality that is connectable to the aerosol generation device 200, the user of the aerosol generation device 200 is enabled to continue using their device for longer. In example aspects in which the extension unit 100 comprises a second connection interface, the connected device to which power is suppled may further comprise a connected other extension unit.

In this case, the means 103 for enabling the at least one additional functionality may comprise at least one power supply. The at least one power supply may, for example, be a rechargeable power supply, e.g. a rechargeable battery. In this case, the extension unit 100 of the third example aspect may itself be advantageously recharged. By way of example, the rechargeable power supply may be a lithium-ion power bank or lithium-polymer power bank. Lithium-ion power banks are, at the time of writing, generally more common.

Lithium-ion (Li-ion) cells are advantageous for this purpose in that they have a relatively low manufacturing cost, and while they have a limited mAh capacity, they tend to last longer as they don't suffer from the memory effect. The memory effect occurs when the battery experiences losses in usable capacity from charging-discharging and recharging them over time. On the other hand, LiPo (lithium-polymer) cells are made thinner and lighter, to the point of resembling a credit card, and can store slightly higher specific energy than Li-ion cells. However, LiPo cells are more expensive to manufacture, suffer from the memory effect, and have shorter lifespans. Table 1 summarizes the most significant differences between Li-ion and LiPo power banks:

TABLE 1

| | Lithium-ion power banks | Lithium-polymer power banks |
|---|---|---|
| Energy | High energy density | Slightly higher energy |
| density | | density |
| Aging | Lose capacity over time | Shorter lifespan |
| | even when not in use | |
| Explosion | Higher risk of exploding | Safer from exploding |
| risk | when overcharged | |
| Price | Low cost | Expensive |
| Charging | Longer charge | Comparatively shorter charge |
| duration | | |
| Size | Slightly big and thick | Compact |
| Weight | Little heavy | Lightweight |
| Conversion | 85%-95% | 75%-90% |
| rate | | |

As the table shows, the main advantages of power banks with LiPo batteries is that they're more compact and more lightweight, both of which are advantageous for the purposes of an extension unit 100 having a power supply functionality. Li-ion batteries are advantageous in terms of low cost and durability.

The power supply functionality may optionally include a number of sun-functionalities. By way of example, these sub-functionalities may comprise charging the power supply 212 of the aerosol generation device 200 with power from the power supply included in the means 103 of the extension unit 100 according to the third example aspect; providing that aerosol generation device 200 with information about the power level of the extension unit 100 itself; supplying power to other extension units connected thereto; and/or charging the power supply included in the means 103 of the extension unit 100 according to the third example aspect.

To this end, the means 103 for enabling the power supply functionality may optionally further comprise a control section. By way of example, the control section may be configured to control at least one of a magnitude and a direction of the supply of power via the first connection interface 101 and/or the second connection interface 102.

By way of example, FIG. 8 a schematic illustration showing an exemplary configuration of a circuit 800 that may be comprised in the extension unit 100 configured according to the third example aspect. The circuit 800 comprises a power supply in the form of a battery 801, a fuel gauge 802, a battery charger 803, a boost DC/DC converter 804 and power supply management logic 805, as well as external connectors 806, 807.

The battery 801 may be any of the power supplies described above, e.g. a lithium-ion power bank or lithium-polymer power bank. The description of the fuel gauge 501 and the battery charger 502 of FIG. 5 applies mutatis mutandis to the fuel gauge 802 and the battery charger 803. The first connection interface 101 and the second connection interface 102 of the extension unit 100 are implemented by external connectors 806, 807.

The boost DC/DC converter 804 is a power converter that steps up the voltage from its input to its output and is used to raise the voltage from the battery 801 of the extension unit 100 to a voltage of 5V in order to charge the power supply 212 of the aerosol generation device 200.

The description of the external connector 507 of FIG. 5 applies mutatis mutandis to external connectors 806, 807. However, the external connectors of the extension unit 100 according to the third example aspect have a more complex interface for power lines in terms of functionality.

In particular, external connector 806 may be referred to as the “Connector Out”, i.e. the connector that connects the extension unit 100 of the third example aspect to the aerosol generation device 200 which it charges. The main difference from other extension units is that the extension unit 100 of the third example aspect is not powered through this connector, but powers other devices. The extension unit 100 of the third example aspect has a power switching circuit if a reverse current is detected on the 5V power supply line, through which it usually powers the extenders. The external connector 807 may be referred to as “Connector In”, i.e. the connector that connects the extension unit 100 of the third example aspect to other extension units or a charger. If another type of extension unit is connected, the extension unit 100 of the third example aspect supplies 5V power to it through the VDD In/Out port. But if the charger is connected, then the extension unit 100 of the third example aspect is charged through the VDD In/Out port.

All these functions for controlling power lines on connectors are implemented in the Power Supply Management Logic 805. This module implements power management and power supply direction through connectors. Since, by default, the device powers all the extenders through the VDD pin of the Connector Out 806, one of the modules' functions is to change the direction of power on this pin to charge the device itself. After changing the direction of power, the extension unit 100 of the third example aspect must independently power the next extension units via the VDD In/Out pin of the Connector In 807. At the same time, if a charger is connected to Connector In 807, then the module should not power the extension units, but switch the supply directions on VDD In/Out for its own charging.

As a fourth example aspect, the at least one additional functionality may comprise a display functionality. In this case, the means 103 for enabling the at least one additional functionality may comprise at least one display unit.

By way of example of a display unit, OLED technology may advantageously be used. OLED technology allows creating small screens, both monochrome and coloured. Such solutions are convenient to use, cheap, and have small dimensions. The advantages of these displays are lightweight and low power consumption.

The use of display unit, e.g. a screen, allows more detailed information to be displayed in a convenient form for the user, such as battery charge in percentage, the number of puffs, amount of free memory on the device, and other statistics useful for the user. In particular, the information displayed by the display unit of the extension unit 100 according to the fourth example aspect may comprise at least one of a level of charge of a power supply of the aerosol generation device, a number of inhalation actions that the user may perform, an amount of free memory of the aerosol generation device, a current time, and a warning notification of the aerosol generation device.

Additionally or alternatively, the display unit may be configured to display information to a user of the aerosol generation device 200 in response to control signalling received from the aerosol generation device 200, e.g. via the first connection interface 101 and/or the second connection interface 102 (in example aspects in which the extension unit 100 comprises an optional second connection interface).

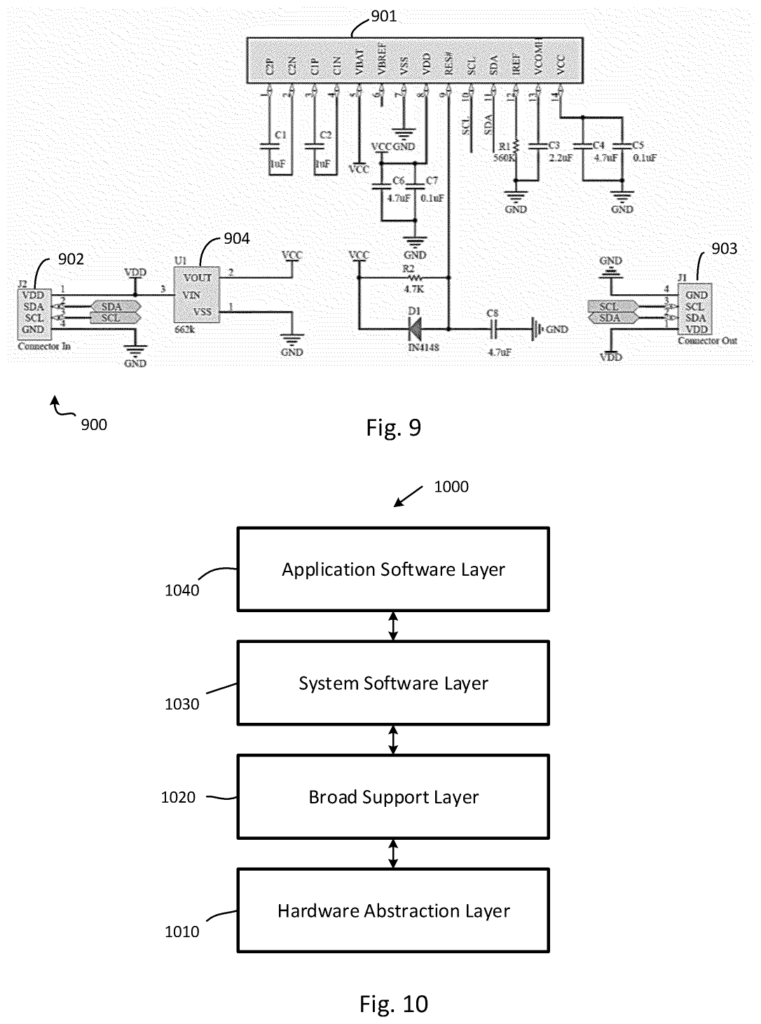

By way of example, FIG. 9 a schematic illustration showing an exemplary configuration of a circuit 900 that may be comprised in the extension unit 100 configured according to the fourth example aspect. The circuit 900 comprises a display unit 901, external connectors 902, 903, and a module 904 configured to convert an input voltage VDD into a supply voltage VCC suitable for the display unit 901. The first connection interface 101 and the second connection interface 102 of the extension unit 100 are implemented by external connectors 902, 903 and the description of the external connector 507 of FIG. 5 applies mutatis mutandis to external connectors 902, 903.

The extension unit 100 according to the fourth example aspect may, as in the circuit 900 of FIG. 9, be configured to receive control signalling from the aerosol generation device 200 via an I2C bus when connected to the aerosol generation device 200.

As a fifth example aspect, the at least one additional functionality may comprise an audio output functionality. In this case the means 103 may comprise an audio output transducer such as, for example, one or more of loudspeakers (e.g. a moving coil loudspeaker), buzzers, horns and sounders.

By way of example, the extension unit 100 according to the fifth example aspect may be controlled to output audio feedback to user indicative of a state of the aerosol generation device 200 when the extension unit 100 is connected thereto. For example, the extension unit 100 of the fifth example aspect may be configured, when connected to the aerosol generation device 200, to output audio feedback indicative of a low battery state of the aerosol generation device 200 or any other warning notification.

Additionally or alternatively, the means 103 may be configured to output audio feedback in response to control signalling received from the aerosol generation device 200, e.g. via the first connection interface 101 and/or the second connection interface 102 (in example aspects in which the extension unit 100 comprises an optional second connection interface) of the extension unit 100 according to the fifth example aspect. By way of example, the extension unit 100 according to the fifth example aspect may be configured to receive control signalling using any of the communication protocols described above in relation to FIG. 3.

The audio feedback output by the extension unit 100 according to the fifth example aspect may be provided in any suitable form, e.g. a tone, a beeping noise, a whistle noise, a melody, etc. Accordingly, the means 103 of the extension unit 100 according to the fifth example aspect may optionally further comprise any additional means necessary to control the audio output transducer to output audio feedback, such as a control section and/or a memory section storing data indicative of the audio feedback (e.g. one or more audio files). Alternatively, the outputting of audio feedback may be controlled by the aerosol generation device 200 when the extension unit 100 according to the fifth example aspect is connected thereto.

The extension unit 100 of each of the first to fifth example aspects described above has a single respective additional functionality and comprises means 103 for enabling that single additional functionality when the extension unit 100 is connected to the aerosol generation device 200. By way of alternative, the extension unit 100 may comprise means 103 for enabling two or more additional functionalities when the extension unit 100 is connected to the aerosol generation device 200.

For example, the extension unit 100 may comprise means 103 for enabling two or more of a flashlight functionality, as described in relation to the first example aspect, a haptic feedback functionality as described in relation to the second example aspect, a display functionality as described in relation to the fourth example aspect, and an audio output functionality described in relation to the fifth example aspect. By configuring extension unit 100 to provide at least two of these functionalities when connected to the aerosol generation device 200, it may be advantageously possible to provide feedback to the user in multiple forms. By way of further example, the extension unit 100 may comprise means 103 for enabling the power supply functionality as described in relation to the third example aspect with at least one of a flashlight functionality as described in relation to the first example aspect, a haptic feedback functionality as described in relation to the second example aspect, a display functionality as described in relation to the fourth example aspect, and an audio output functionality described in relation to the fifth example aspect. In this way, it may be possible to advantageously provide information about a state of the power supply of the extension unit 100 or the aerosol generation device 200 to the user, e.g. charging time left, charging state, remaining power, etc.

More generally, the extension unit 100 may comprise means 103 for enabling any suitable number or combination of additional functionalities, including those discussed above or any other suitable functionalities.

For the development of the extension unit 100 and, more generally, the aerosol generation system comprising the extension unit 100 and the aerosol generation device 200, the present inventors have recognized that use of a layered architecture for the software may be advantageous in order to allow for further maintenance and scaling.

FIG. 10 is a block diagram illustrating a layer software architecture 1000 suitable for use with the disclosed example aspects. The layered software architecture 1000 of FIG. 10 comprises a Hardware Abstraction Layer (HAL) 1010, a Board Support Layer (BSP) 1020, a System Software Layer 1030 and an Application Software Layer 1040.

The HAL 1010 provides a generic multi-instance simple set of APIs (application programming interfaces) to interact with the upper layer (application, libraries, and stacks). The HAL 1010 is composed of generic and extension APIs. The HAL 1010 is directly built around a generic architecture. The HAL 1010 allows the built-upon layers, such as the middleware layer, to implement their functions without knowing in-depth on how to use the MCU. This layer provides access to hardware interfaces (I2C, SPI, UART, etc.), registers, and MCU interrupts.

The BSP 1020 is the software layer containing hardware-specific drivers and other routines to allow a particular software system (traditionally a real-time operating system, or RTOS) to function in a specific hardware environment. BSPs are customizable, allowing the user to specify which drivers and routines should be included in the build based on their selection of hardware and software options. The drivers and board support layer 1020 contain hardware-specific drivers and other routines, which implement support of all equipment and features of a specific hardware platform.

The system software layer 1030 consists of separate threads/modules/services that provide thread-safe access to hardware resources, collect and transfer data to the application layer, perform system monitoring of hardware resources. Also, system software layer 1030 provides an application programming interface (API) to an abstract operating system.

The application software layer 1040 describes all the business logic of user interaction with the device.

The aerosol generation device 200 may be configured in any suitable way to perform control of communication with one or more extension units via a communication bus (e.g. an I2C bus or any other suitable bus, as described above in relation to FIGS. 4A to 4E).

By way of example, the control section 211 of aerosol generation device 200 may be configured to perform control of communication with one or more extension units via the communication bus. For example, the control section 211 may be provided with a memory section which stores a computer program which, when executed by a control section 211 of the aerosol generation device 200, causes the control section 211 to perform control of communication with one or more extension units 110, 120, 130 via a communication bus.

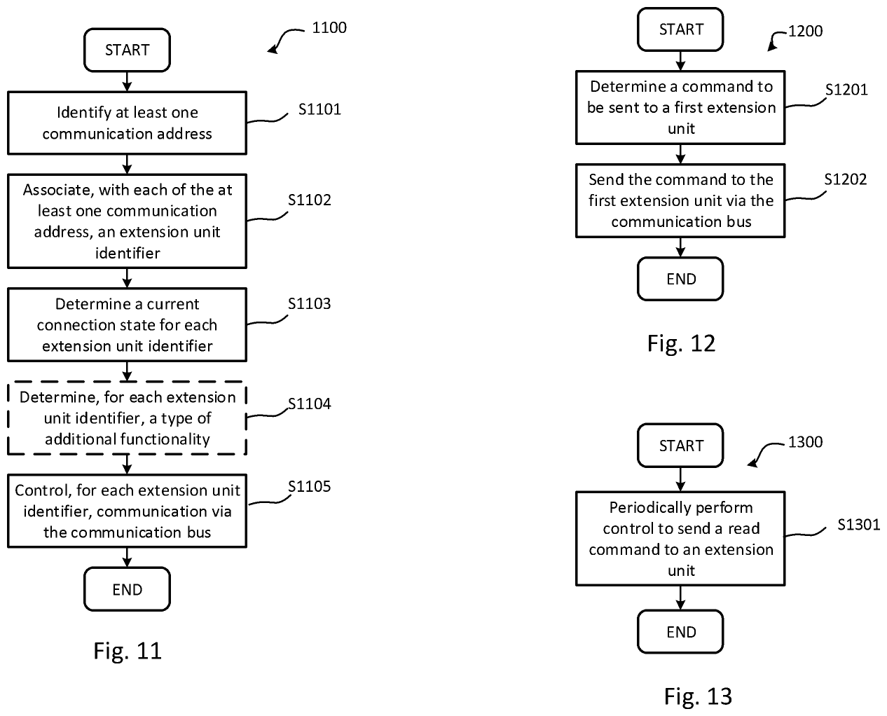

FIG. 11 is a flow diagram illustrating a process 1100 by which the aerosol generation device 200 of FIG. 3 controls communication with one or more extension units 110, 120, 130 via a communication bus, in accordance with an example aspect herein.

By way of example, the control section 211 of the aerosol generation device 200 may control the aerosol generation device 200 to perform the process 1100 of FIG. 11. As described above in relation to FIGS. 3, 6A and 6B, each of the one or more extension units 110, 120, 130 may be connectable to the aerosol generation device 200 and configured to enable at least one additional functionality of the aerosol generation device 200, further to aerosol generation, when connected to the aerosol generation device 200.

In process step S1101 of FIG. 11, the aerosol generation device 200 identifies at least one communication address among a plurality of communication addresses of the communication bus for which signalling is received from an extension unit, among the one or more extension units 110, 120, 130, using the communication address.

A communication bus may include a plurality of possible communication addresses that a device communicating on the communication bus may use. Such a plurality of communication addresses may comprise a fixed number of possible communication addresses that may be used. By way of example, as discussed above in relation to FIGS. 4A and 4B, I2C addresses may have 7 bits such that up to 128 devices may be accommodated on an I2C communication bus, since a 7-bit number can be from 0 to 127. More addresses are available where 10-bit addresses are used. Additionally or alternatively, the plurality of communication addresses may include a set of communication addresses potentially available for use by extension units 110, 120, 130 obtained by removing the communication address used by the aerosol generation device 200 from a fixed number of possible communication addresses.

As such, the aerosol generation device 200 may, for example, determine, for each of the plurality of communication addresses, whether signalling has been received from an extension unit 110, 120, 130 which uses that communication address to communicate on the communication bus. An extension unit 110, 120, 130 may be considered to communicate using a particular communication address where signalling can be addressed to this extension unit over the communication bus using said address. Accordingly, the identified at least communication address represents a set of communication addresses that are determined to be used by extension units 110, 120, 130 on the communication bus.

By way of example, the signalling may be any suitable message, notification or indication that the extension units 110, 120, 130 may send to the aerosol generation device 200 via the communication bus.

By way of more specific example, the received signalling may comprise an acknowledgement. For example, in example aspects such as the present example aspect in which the communication bus is an I2C bus, the aerosol generation device 200 (as the master device) may initiate communication on the I2C bus by transmitting signalling to each of the plurality of communication addresses and each extension unit 110, 120, 130 connected to the communication bus (i.e. slave devices) may return an acknowledgement. By way of further example, the aerosol generation device 200 may attempt to transmit signalling to each extension unit 110, 120, 130 a fixed number of times before determining no acknowledgement has been received.

Table 2 provides an example of the signalling received over the communication bus by aerosol generation device 200 for exemplary communication addresses {000, 001, 010, 011, 100, 101, 110, 111}:

TABLE 2

| Communication Address | Signalling Received? |
|---|---|
| 000 | ACK |
| 001 | — |
| 010 | — |
| 011 | ACK |
| 100 | ACK |
| 101 | — |
| 110 | — |
| 111 | — |

In the example of Table 2, the aerosol generation device 200 may identify communication addresses {000, 011, 100} as communication addresses for which signalling is received from an extension unit, among the one or more extension units 110, 120, 130, using the communication address. By way of example, extension unit 110 may communicate using communication address 000, extension unit 120 may communicate using communication address 011, and extension unit 130 may communicate using communication address 100.

In process step S1102 of FIG. 11, the aerosol generation device 200 associates, with each of the at least one communication address, an extension unit identifier indicating the extension unit from which the signalling was received.

That is, each extension unit identifier is indicative of or identifies a particular extension unit 110, 120, 130.

That is, each communication address from which the aerosol generation device 200 receives signalling over the communication bus may be associated with an extension unit identifier indicative of the extension unit which sent the signalling. By way of example, each extension unit identifier may comprise any suitable information and be of any suitable form that allows an extension unit to be uniquely identified by the aerosol generation device 200. For example, the extension unit identifier may be an identification number in the form of alphanumeric characters, a decimal number, hexadecimal number or binary number. The extension unit identifier associated with each identified communication address may be based on that communication address (e.g. the communication address or a permutation thereof may be used as the extension unit identifier).

Table 3 provides an example of the extension unit identifiers {aaa, bbb, ccc} associated with the communication addresses {000, 011, 100}, respectively, identified from Table 2 above:

TABLE 3

| Communication Address | Extension Unit Identifier | Extension Unit |
|---|---|---|
| 000 | aaa | 110 |
| 011 | bbb | 120 |
| 100 | ccc | 130 |

That is, in this example, extension unit identifier aaa identifies extension unit 110, extension unit identifier bbb identifies extension unit 120, and extension unit identifier ccc identifies extension unit 130.

In process step S1103 of FIG. 11, the aerosol generation device 200 determines, for each extension unit identifier, a current connection state of the extension unit 110, 120, 130 indicated by the extension unit identifier.

By way of example, the respective connection states of extension units 110, 120, 130 may indicate whether or not that extension unit is physically connected to the aerosol generation device 200. By way of further example, the aerosol generation device 200 may be configured to determine whether each extension unit 110, 120, 130, for which an extension unit identifier is associated, is physically connected thereto over the communication bus.

Each extension unit 110, 120, 130 that has an associated extension unit identifier will have been connected to the aerosol generation device 200 at the point when signalling is received therefrom by the aerosol generation device 200. However, there is a possibility that the user may disconnect an extension unit from the aerosol generation device 200 or an extension unit may inadvertently be disconnected from the aerosol generation device 200 (e.g. due to a faulty physical connection or the user not having corrected attached the extension unit to the aerosol generation device 200). As such, process step 1103 may serve to verify the connection status of each extension unit that has an associated extension unit identifier.

Table 4 provides an example of the extension unit identifiers {aaa, bbb, ccc} and the communication addresses {000, 011, 100} from Table 3 above, with the corresponding connection status of each extension unit indicated by the extension unit identifiers {aaa, bbb, ccc}:

TABLE 4

| Communication | Extension Unit | | Connection |
|---|---|---|---|
| Address | Identifier | Extension Unit | Status |
| 000 | aaa | 110 | connected |
| 011 | bbb | 120 | connected |
| 100 | ccc | 130 | not connected |

The process 1100 of process of FIG. 11 may optionally comprise process step 1104. In optional process step 1104, the aerosol generation device 200 determines, for each extension unit identifier, a type of the at least one additional functionality enabled by the extension unit 110, 120, 130 indicated by the extension unit identifier.

By way of example, the type of the at least one additional functionality may be the particular functionality provided by the extension unit in question. For example, the type of the at least one additional functionality may be one of a flashlight functionality, a haptic feedback functionality, a power supply functionality, a display functionality and an audio output functionality. By way of alternative example, the of the at least one additional functionality may be based on the means 103 for enabling at least one additional functionality, e.g. whether the means 103 comprises a sensor, an actuator or a power supply.

The type of an extension unit 110, 120, 130 may be determined in any suitable way. By way of example, each extension unit 110, 120, 130 may be configured in advance to use one or more specific communication addresses only for communicating on the communication bus. In this case, the aerosol generation device 200 may be provided in advance with information indicating a correspondence between each communication address and a type of extension unit that may use that communication address such that the aerosol generation device 200 may determine that type of the at least one additional functionality based on this correspondence. Alternatively, the aerosol generation device 200 may be configured to determine a type of the at least one additional functionality by exchanging further signalling over the communication bus with the connected extension units 110, 120, 130.

In process step S1105, the aerosol generation device 200 controls, for each extension unit identifier, communication with the extension unit 110, 120, 130 indicated by the extension unit identifier via the communication bus using the communication address associated with the extension unit identifier and in accordance with the determined current connection state of the extension unit 110, 120, 130.

In example aspects such as the present example aspect in which the aerosol generation device performs optional process step S1104, the aerosol generation device 200 may control, for each extension unit identifier, communication with the extension unit 110, 120, 130 indicated by the extension unit identifier in accordance with the determined type of the at least one additional functionality enabled by the extension unit 110, 120, 130 indicated by the extension unit identifier.

The aerosol generation device 200 may control communication with a particular extension unit 110, 120, 130 via the communication bus using a particular communication address by addressing commands and other messages to be sent to that extension unit to that communication address. This may be achieved, by way of example, including that communication address in an address frame of a message (signalling) to be sent to that extension unit.

The aerosol generation device 200 may control communication with a particular extension unit 110, 120, 130 in accordance with the determined current connection state of the extension unit 110, 120, 130 and, optionally, a type of the at least one additional functionality enabled by the extension unit 110, 120, 130 in any suitable way.

By way of example, where the current connection state of the extension unit indicates that the extension unit is connected to the aerosol generation device 200, the aerosol generation device 200 may send commands to the extension unit to control the at least one functionality enabled thereby. In contrast, where the current connection state of the extension unit indicates that the extension unit is not connected to the aerosol generation device 200, the aerosol generation device 200 may not communicate with the extension unit or may attempt to attempt to transmit signalling to the extension unit a fixed number of times before determining no acknowledgement has been received.

By way of further example, the form and/or content of commands and other messages sent by the aerosol generation device 200 to a particular extension unit may depend on type of the at least one additional functionality enabled by the extension unit. More specifically, a command sent to an extension unit having an audio output functionality may include a data field containing information indicative of audio content to be output by the extension unit, whereas a command sent to an extension unit having a flashlight functionality may not include such a data field and may cause the extension unit to toggle between a light emitting state and a non-light emitting state.

More generally, the aerosol generation device 200 controls, for each extension unit identifier, communication with the extension unit 110, 120, 130 indicated by the extension unit identifier via the communication bus using the communication address associated with the extension unit identifier and in accordance with the determined current connection state of the extension unit 110, 120, 130 by performing one or more of the processes described in relation to FIGS. 12 to 16.

FIG. 12 is a flow diagram illustrating an exemplary process 1200 by which the aerosol generation device 200 of FIG. 3 may control communication with an extension unit 110, 120, 130 via a communication bus, in accordance with a first example aspect herein.

In process step S1201 of FIG. 12, the aerosol generation device 200 determines a command to be sent to a first extension unit among the extension units indicated by the extension unit identifiers in accordance with the determined type of at least one additional functionality enabled by the first extension unit.

By way of example, for an extension unit having a flashlight functionality, the determined command may be a command that causes the at least one LED of the extension unit to emit light and/or to blink or dim the emitted light in response to the command. By way of further example, for an extension unit having a haptic feedback functionality, the determined command may be a command that causes the extension unit to generate haptic feedback for the user, e.g. in the form of vibrations. Furthermore, for an extension unit having a display functionality or an audio output functionality, the determined command may be a command that causes the extension unit to display information or output audio content, respectively, to a user of the aerosol generation device 200.

More generally, the determined command may depend on whether the means 103 of the extension unit, to which the command is to be sent, comprises a sensor or an actuator. For example, a read command may be sent to an extension unit of which the means 103 comprise a sensor whereas a write command may be sent to an extension unit of which the means 103 comprise an actuator.

In process step S1202 of FIG. 12, the aerosol generation device 200, sends the command to the first extension unit via the communication bus using the communication address associated with the extension unit identifier indicating the first extension unit.

FIG. 13 is a flow diagram illustrating an exemplary process 1300 by which the aerosol generation device 200 of FIG. 3 may control communication with an extension unit 110, 120, 130 via a communication bus, in accordance with a second example aspect herein.

In process step S1301 of FIG. 13, the aerosol generation device 200 periodically performs, for each extension unit identifier, in a case where the type of the at least one additional functionality enabled by the extension unit indicated by the extension unit identifier is a first type, control to send a read command to the extension unit using the communication address associated with the extension unit identifier.

By way of example, the first type may indicate that the means 103 of the extension unit comprises a sensor (e.g. a humidity, pressure or temperature sensor) such that it is possible for the aerosol generation device 200 to regularly obtain the data output by the sensor.

By way of example, the control to send a read command to an extension unit may be performed periodically in accordance with a predefined frequency associated with the extension unit or the type of the at least one additional functionality enabled by the extension unit. For example, the predefined frequency may be once a minute, once a second, or multiple times a second.

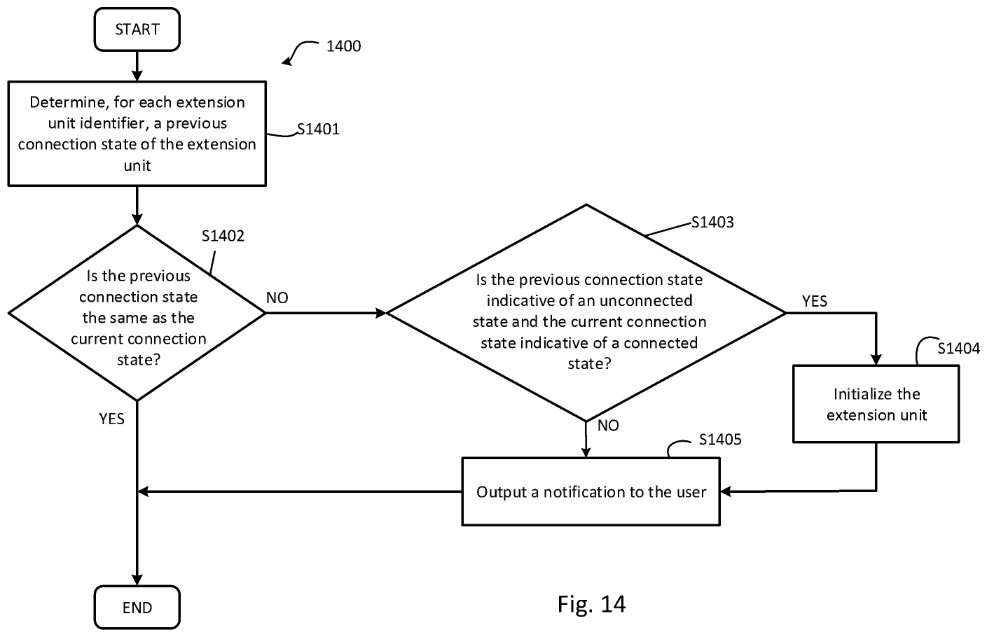

FIG. 14 is a flow diagram illustrating an exemplary process 1400 by which the aerosol generation device 200 of FIG. 3 may control communication with an extension unit 110, 120, 130 via a communication bus, in accordance with a third example aspect herein.

The process 1400 of FIG. 14 may be performed in respect of each extension unit identifier.

In process step S1401 of FIG. 14, the aerosol generation device 200 determines a previous connection state of the extension unit indicated by a given extension unit identifier.

In process step S1402 of FIG. 14, the aerosol generation device 200 determines whether the previous connection state of the extension unit indicated by the extension unit identifier is the same as current connection state of the extension unit.

In a case where the previous connection state of the extension unit indicated by the extension unit identifier is the same as current connection state of the extension unit, process 1400 ends. In a case where the previous connection state of the extension unit indicated by the extension unit identifier is not the same as current connection state of the extension unit, the process 1400 proceeds to process step S1403.

In process step S1403 of FIG. 14, the aerosol generation device 200 determines whether the previous connection state of the extension unit indicated by the extension unit identifier is indicative of a non-connected state and the current connection state of the extension unit is indicative of a connected state.

In a case where, the previous connection state of the extension unit indicated by the extension unit identifier is indicative of a non-connected state and the current connection state of the extension unit is indicative of a connected state, the process 1400 proceeds to process step 1404. Otherwise, the process 1400 proceeds to process step 1405.

In process step 1404 of FIG. 14, the aerosol generation device 200 initializes the extension unit. By way example, initializing the extension unit may comprise setting values of one or more parameters of the extension unit. The parameters of the extension unit may be dependent on the means 103 comprises by the extension unit. By way of example, parameters may include an operational frequency of a sensor or a synchronize time.

In process step 1405 of FIG. 14, the aerosol generation device 200 outputs a notification to the user of the aerosol generation device 200. For example, this may allow a user to be alerted where an extension unit's connection state has changed, e.g. an extension unit has become disconnected from the aerosol generation device 200.

After process step S1405 of FIG. 14, process 1400 ends.

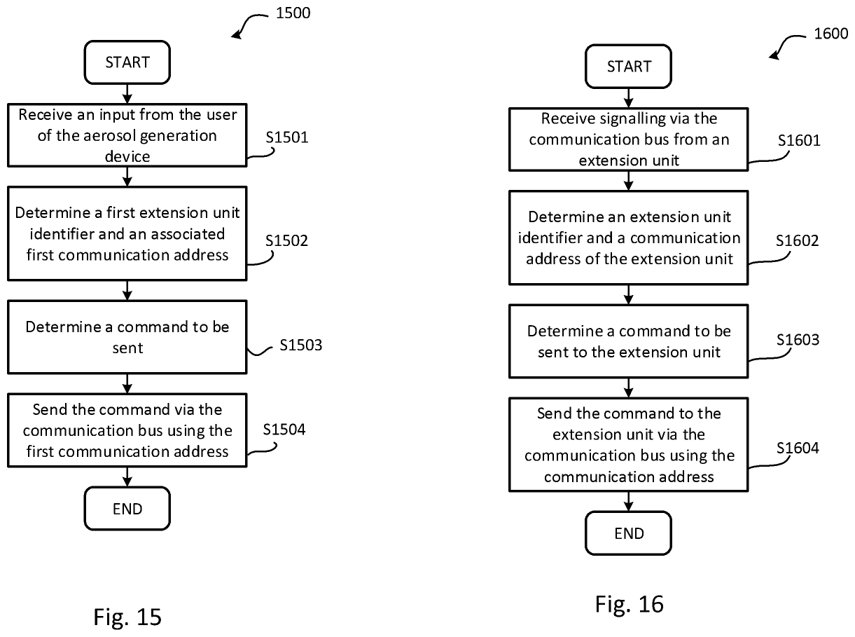

FIG. 15 is a flow diagram illustrating an exemplary process 1500 by which the aerosol generation device 200 of FIG. 3 may control communication with an extension unit 110, 120, 130 via a communication bus, in accordance with a fourth example aspect herein.

In process step S1501 of FIG. 15, the aerosol generation device 200 receives input from a user of the aerosol generation device via an input unit of the aerosol generation device (e.g. button 17 shown in FIG. 1 or any of the at least one I/O section 15 described in relation to FIG. 2).

In process step S1502 of FIG. 15, the aerosol generation device 200 determines a first extension unit identifier and an associated first communication address based on the received input.

In process step S1503 of FIG. 15, the aerosol generation device 200 determines a command to be sent to an extension unit indicated by the first extension unit identifier based on the received input.

In process step S1504 of FIG. 15, the aerosol generation device 200 sends the command to the extension unit via the communication bus using the first communication address associated.

By way of example, the user may provide input to a touch screen of the aerosol generation device 200 indicative of an instruction to turn on the LEDs of an extension unit enabling a flashlight functionality. As such, the aerosol generation device 200 may recognise the extension unit identifier of the extension unit enabling the flashlight functionality and associated communication address based on the received input. The aerosol generation device 200 may further determine the command as one which instructs the extension unit to turn on the LEDs and send the command to the appropriate extension unit.

FIG. 16 is a flow diagram illustrating an exemplary process 1600 by which the aerosol generation device 200 of FIG. 3 may control communication with an extension unit 110, 120, 130 via a communication bus, in accordance with a fifth example aspect herein.

In process step 1601 of FIG. 16, the aerosol generation device 200 receives via the communication bus signalling from an extension unit among the one or more extension units indicative of input by a user of the aerosol generation device.

In process step 1602 of FIG. 16, the aerosol generation device 200 determines an extension unit identifier and an associated communication address of the extension unit.

In process step 1603 of FIG. 16, the aerosol generation device 200 determines a command to be sent to the extension unit based on the received signalling.

In process step 1604 of FIG. 16, the aerosol generation device 200 sends the command to the extension unit via the communication bus using the determined communication address associated.

By way of example, the user may provide input to an input unit of an extension unit enabling a flashlight functionality, which the extension unit may forward to the aerosol generation device 200. The aerosol generation device 200 may determine the extension unit identifier of the extension unit as that associated with the communication address used by the extension unit from which the input was received. The aerosol generation device 200 may further determine the command as one which instructs the extension unit to turn on the LEDs based on the received signalling and send the command to the appropriate extension unit.

Turning back to process 1100 of FIG. 11, this process allows the aerosol generation device 200 to simply and efficiently scan through communication addresses of the communication bus in order to identify which addresses are being used for communication by connected extension units 110, 120, 130 and to appropriately control communication with these extension units 110, 120, 130 over the communication bus.

The process 1100 of FIG. 11 may be performed periodically by the aerosol generation device 200. In this way, the aerosol generation device 200 may maintain up-to0date information on the connected extension units 110, 120, 130.

As such, the process 1100 of FIG. 11 may facilitate provision of a means by which additional functionalities can be provided in an aerosol generation device 200 only as required. Furthermore, the process 1100 of FIG. 11 may facilitate provision of a means by which functionalities can be added to an aerosol generation device 200 while also ensuring that the device remains of a relatively small size and relatively low weight and without exceeding any limitations of the memory space, power supply and user interface of the aerosol generation device 200.

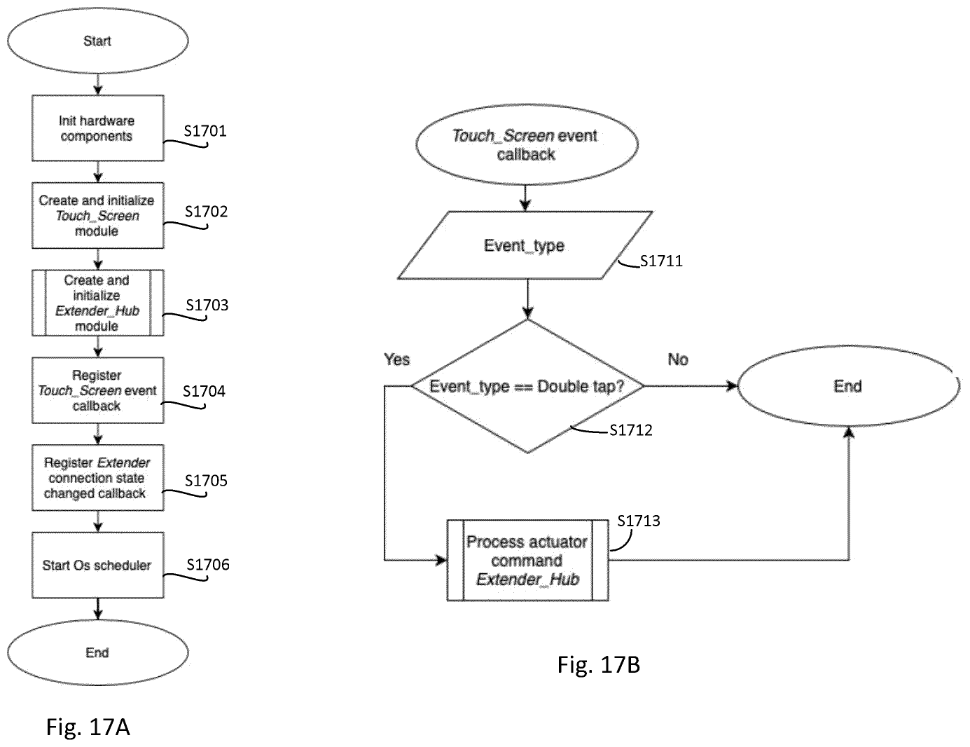

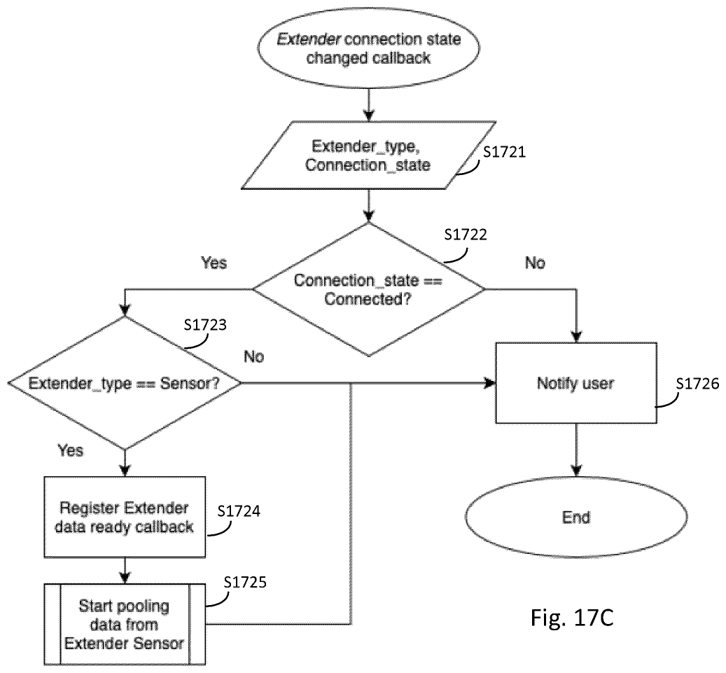

FIGS. 17A to 17C, 18A to 18G, 19A to 19C and 20A to 20C are flow diagrams illustrating an example of how the process 1100 of FIG. 11 may be implemented on the layer software architecture 1000 shown in FIG. 10 of an aerosol generation device 200 having a touch screen as an I/O section. In the following, extension units are also referred to as extenders.

FIGS. 17A to 17C are flow diagrams illustrating operations performed by the aerosol generation device 200 on the Application Software Layer 1040 of the layer software architecture 1000 shown in FIG. 10.

In process step S1701 of FIG. 17A, the aerosol generation device 200 initializes its hardware components.

In process step S1702 of FIG. 17A, the aerosol generation device 200 creates and initializes a touch screen module.

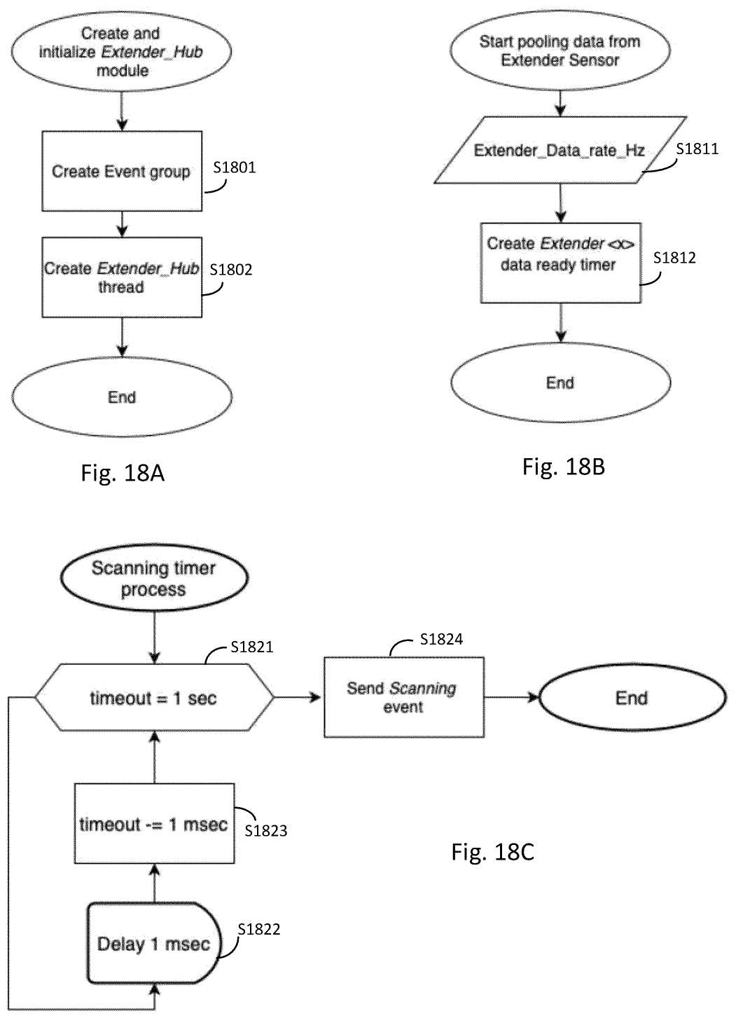

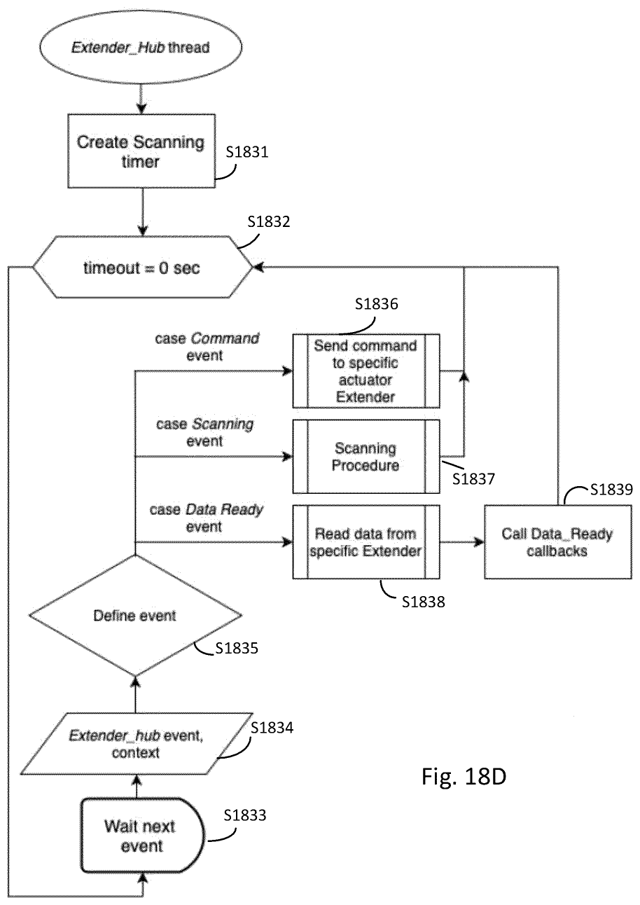

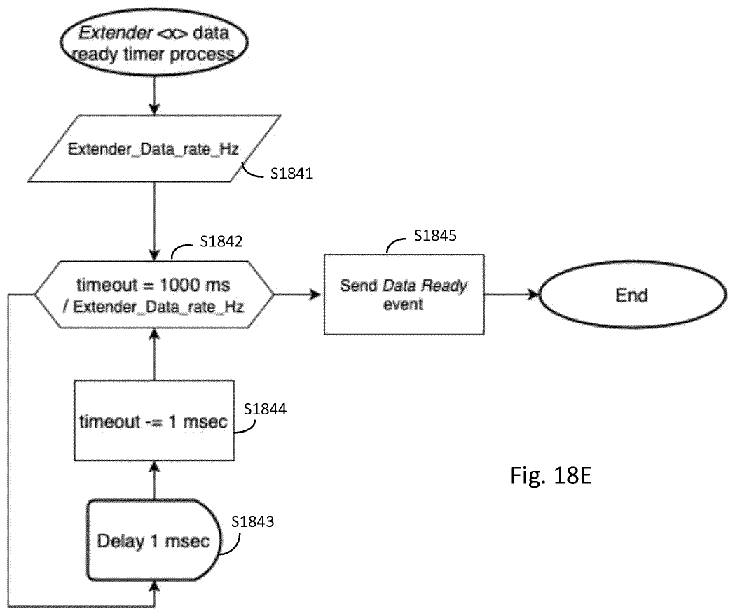

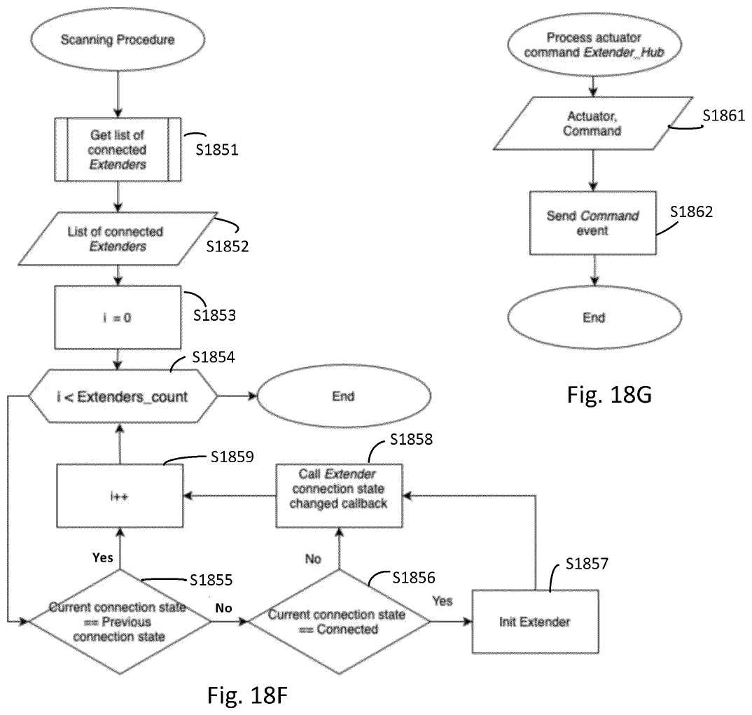

In process step S1703 of FIG. 17A, the aerosol generation device 200 performs a process to create and initialize an extender hub module. This process is described below in relation to FIG. 18A.

In process step S1704 of FIG. 17A, the aerosol generation device 200 registers a touch screen event callback process, described in relation to FIG. 17B.

In process step S1705 of FIG. 17A, the aerosol generation device 200 registers an extender connection state changed callback process, described in relation to FIG. 17C.

In process step S1706 of FIG. 17A, the aerosol generation device 200 starts an OS (Operating System) scheduler and then ends the process.

FIG. 17B is a flow diagram illustrating the touch screen event callback process registered in process step S1704 of FIG. 17A.

In process step S1711 of FIG. 17B, the aerosol generation device 200 receives, as input to the touch screen event callback process, an event type.

In process step S1712 of FIG. 17B, the aerosol generation device 200 determines whether the event type is a double tap of the touch screen.

In a case where the event type is a double tap of the touch screen, the touch screen event callback process proceeds to process step S1713. Otherwise, the touch screen event callback process ends.

In process step S1713 of FIG. 17B, the aerosol generation device 200 executes an actuator command extender hub process, as described in relation to FIG. 18G. Then the touch screen event callback process ends.

FIG. 17C is a flow diagram illustrating the extender connection state changed callback process registered in process step S1705 of FIG. 17A.

in process step S1721 of FIG. 17C, the aerosol generation device 200 receives, as input to the extender connection state changed callback process, an extender type and a connection state. These inputs may be provided by the scanning procedure described in relation to FIG. 18F.

In process step S1722 of FIG. 17C, the aerosol generation device 200 determines whether the connection state is indicative of the extender being connected.

In a case where the connection state is indicative of the extender being connected, the extender connection state changed callback process proceeds to process step S1723. Otherwise, the extender connection state changed callback process proceeds to process step S1726.

In process step S1723 of FIG. 17C, the aerosol generation device 200 determines whether the extender type is a sensor.

In a case where the extender type is a sensor, the extender connection state changed callback process proceeds to process step S1724. Otherwise the extender connection state changed callback process proceeds to process step 1726.

In process step S1724 of FIG. 17C, the aerosol generation device 200 registers an extender data ready callback process.

In process step S1725 of FIG. 17C, the aerosol generation device 200 executes a process for pooling data from an extender sensor, which is described in relation to FIG. 18B.

In process step S1726 of FIG. 17C, the aerosol generation device 200 provides a notification to the user of the aerosol generation device 200. Then the extender connection state changed callback process ends.

FIGS. 18A to 18G are flow diagrams illustrating operations performed by the aerosol generation device 200 on the System Software Layer 1030 of the layer software architecture 1000 shown in FIG. 10.

FIG. 18A is a flow diagram illustrating a process to create and initialize an extender hub module executed in process step S1703 of FIG. 17A.

In process step S1801 of FIG. 18A, the aerosol generation device 200 creates an event group, which is a container for a set of events that stores events before they are processed in the process described in relation to FIG. 18D.

In process step S1802 of FIG. 18A, the aerosol generation device 200 creates an extender hub thread, described in relation to FIG. 18D. Then the process ends.

FIG. 18B is a flow diagram illustrating a process for pooling data from an extender sensor executed in process step 1725 of FIG. 17C.

In process step S1811 of FIG. 18B, the aerosol generation device 200 receives, as input to the process for pooling data from an extender sensor, an extender data rate in Hz.

In process step S1812 of FIG. 18B, the aerosol generation device 200 creates an extender <x> data ready timer process, which is described in relation to FIG. 18E. Then the process for pooling data from an extender sensor ends.

FIG. 18C is a flow diagram illustrating a scanning timer process.

In process step S1821 of FIG. 18C, the aerosol generation device 200 sets the value of a timeout equal to 1 second.

In process step S1822 of FIG. 18C, the aerosol generation device 200 delays execution of the process for pooling data from an extender sensor for 1 millisecond.

In process step S1823 of FIG. 18D, the aerosol generation device 200 decrements the value of the timeout by 1 millisecond.

Once the timeout reaches zero, in process step S1824 of FIG. 18C, the aerosol generation device 200 sends a scanning event, as an output of the process for pooling data from an extender sensor (in one illustrative example of the depicted flowchart, one may set the timeout value to 1000 ms and delay to 1 millisecond; the timeout value may be decreased by 1 millisecond and the process repeated while the timeout value is more than 0; once zero is reached, the event is fired). The process for pooling data from an extender sensor then ends.

FIG. 18D is a flow diagram illustrating the extender hub thread created in process step S1802 of FIG. 18A.

In process step S1831 of FIG. 18D, the aerosol generation device 200 creates a scanning timer, as described in relation to FIG. 18C.

In process step S1832 of FIG. 18D, the aerosol generation device 200 sets the value of a timeout equal to 0 seconds.

In process step S1833 of FIG. 18D, the aerosol generation device 200 waits until the next event is received.

In process step S1834 of FIG. 18D, the aerosol generation device 200 receives, as input to the extender hub thread, an extender hub event context.

In process step S1835 of FIG. 18D, the aerosol generation device 200 defines the event.

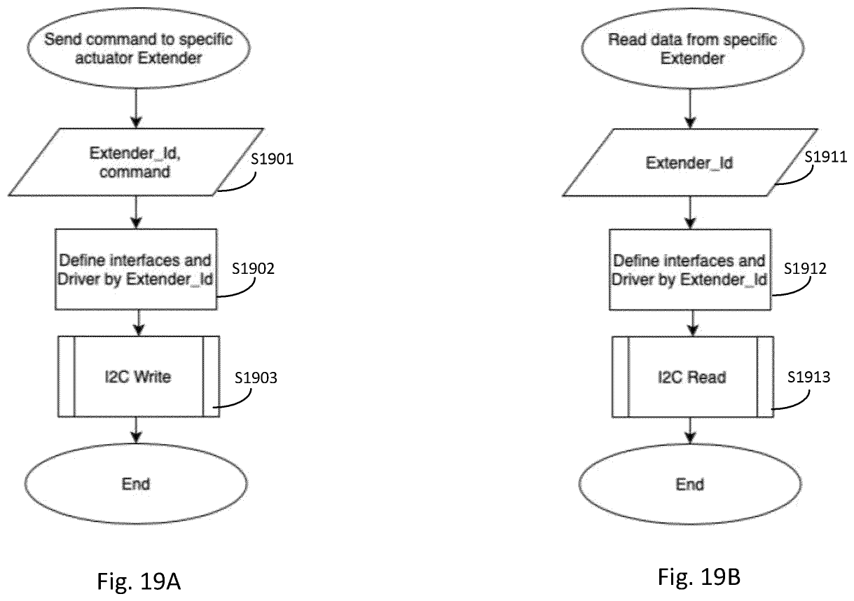

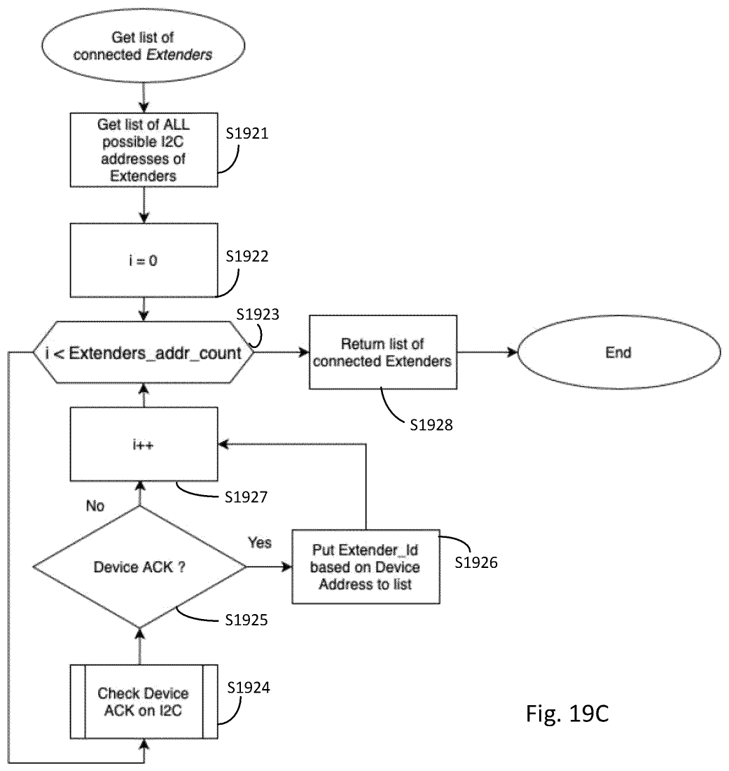

In process step S1836 of FIG. 18D, in response to receiving a command event (which is an output of the actuator command extender hub process described in relation to FIG. 18G), the aerosol generation device 200 executes a process to send a command to a specific actuator extender, as described in relation to FIG. 19A. Then the extender hub thread returns to process step S1832.

In process step S1837 of FIG. 18D, in response to receiving a scanning event (which is an output of the process for pooling data from an extender described in relation to FIG. 18C), the aerosol generation device 200 executes a scanning procedure, as described in relation to FIG. 18F. Then the extender hub thread returns to process step S1832.

In process step S1838 of FIG. 18D, in response to receiving a data ready event (which is an output of the extender <x> data ready timer process described in relation to FIG. 18E), the aerosol generation device 200 executes a process to read data from a specific extender, as described in relation to FIG. 19B. Then the extender hub thread proceeds to process step S1839.

In process step 1839 of FIG. 18D, the aerosol generation device 200 calls a data ready callback process. Then the extender hub thread returns to process step S1832.

FIG. 18E is a flow diagram illustrating the extender <x> data ready timer process created in process step 1812 of FIG. 18B.

In process step S1841 of FIG. 18E, the aerosol generation device 200 receives, as input to the extender <x> data ready timer process, an extender data rate in Hz.

In process step S1842 of FIG. 18E, the aerosol generation device 200 sets the value of a timeout equal to 1000 milliseconds divided by the extender data rate in Hz received in process step S1841.

In process step S1843 of FIG. 18E, the aerosol generation device 200 delays execution of the extender <x> data ready timer process for 1 millisecond.

In process step S1844 of FIG. 18E, the aerosol generation device 200 decrements the value of the timeout by 1 millisecond.

Once the timeout reaches zero, in process step S1845 of FIG. 18E, the aerosol generation device 200 sends a data ready events, as an output of the extender <x> data ready timer process. The extender <x> data ready timer process then ends (an illustrative example may be similarly derived as illustrated above with reference to FIG. 18C, see the explanation in relation to step S1824).

FIG. 18F is a flow diagram illustrating a scanning procedure executed in process step S1837 of FIG. 18D.

In process step S1851 of FIG. 18F, the aerosol generation device 200 executes a process to get a list of connected extenders, as described in relation to FIG. 19C.

In process step S1852 of FIG. 18F, the aerosol generation device 200 receives, as an input to the scanning procedure from the execution of the process to get a list of connected extenders, a list of connected extenders.

In process step S1853 of FIG. 18F, the aerosol generation device 200 sets a variable i equal to zero.

In process step S1854 of FIG. 18F, the aerosol generation device 200 sets the scanning procedure to loop while i is less than the number of connected extenders.

In process step S1855 of FIG. 18F, the aerosol generation device 200 determines whether a current connection state of an extender corresponding to the value of i is the same as a previous connection state.

In a case where the current connection state of an extender corresponding to the value of i is not the same as the previous connection state, the scanning procedure proceeds to process step S1856. Otherwise, the scanning procedure proceeds to process step S1859.

In process S1856, the aerosol generation device determines whether the current connection state of an extender corresponding to the value of i is indicative of the extender being connected.

In a case where the current connection state of an extender corresponding to the value of i is indicative of the extender being connected, the scanning procedure proceeds to process step S1857. Otherwise, the scanning procedure proceeds to process step S1858.

In process step S1857 of FIG. 18F, the aerosol generation device 200 initializes the extender corresponding to the value of i.

In process step S1858 of FIG. 18F, the aerosol generation device 200 calls the extender connection state changed callback described in relation to FIG. 17C.

In process step S1859 of FIG. 18F, the aerosol generation device 200 increments the value of i by one. The scanning procedure ends when the value of i becomes equal to the number of connected extenders.

FIG. 18G is a flow diagram illustrating the actuator command extender hub process executed in process step S1713 of FIG. 17B.

In process step S1861 of FIG. 180, the aerosol generation device 200 receives an actuator command (e.g. information indicative of input by a user to an extender using an actuator of that extender is transmitted to the aerosol generation device 200 over the communication bus or input by a user using an actuator, such as a touch screen, of the aerosol generation device 200).

In process step S1862 of FIG. 180, the aerosol generation device sends, as output of the actuator command extender hub process, a command event. Then actuator command extender hub process then ends.

FIGS. 19A to 19C are flow diagrams illustrating operations performed by the aerosol generation device 200 on the Board Support Layer 1020 of the layer software architecture 1000 shown in FIG. 10.

FIG. 19A is a flow diagram illustrating the process to send a command to a specific actuator extender executed in process step 1836 of FIG. 18D.

In process step S1901 of FIG. 19A, the aerosol generation device receives, as input to the process to send a command to a specific actuator extender, an extender ID and a command.

In process step S1902 of FIG. 19A, the aerosol generation device 200 defines interfaces and a driver based on the extender ID.

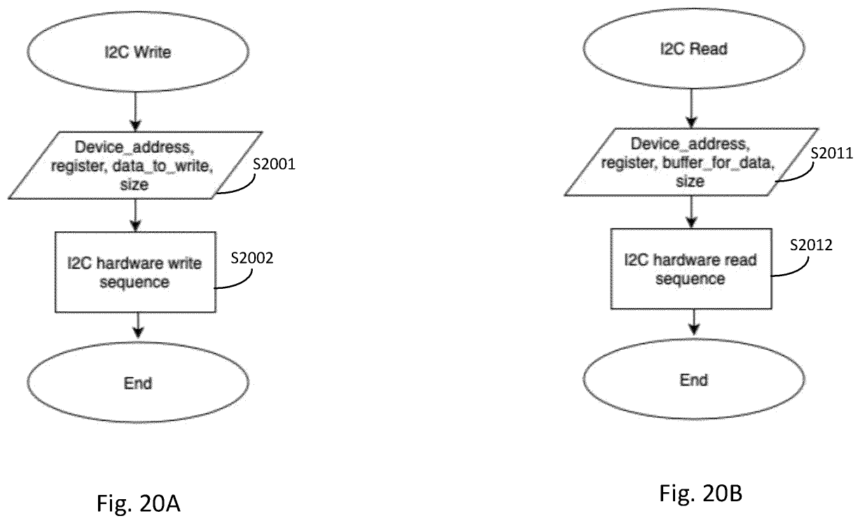

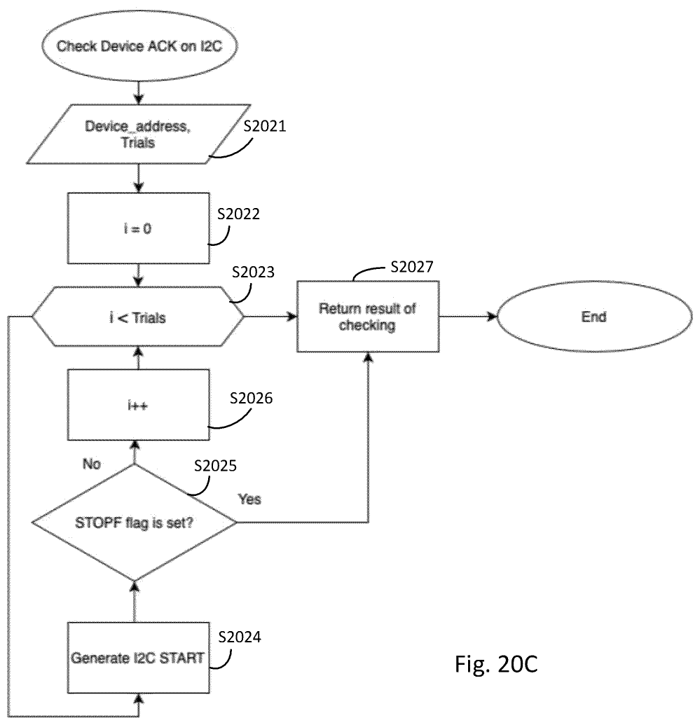

In process step S1903 of FIG. 19A, the aerosol generation device 200 executes an I2C Write process, described in relation to FIG. 20A. The process to send a command to a specific actuator extender then ends.

FIG. 19B is a flow diagram illustrating the process to read data from a specific extender executed in process step 1838 of FIG. 18D.

In process step S1911 of FIG. 19B, the aerosol generation device receives, as input to the process to read data from a specific extender, an extender ID.

In process step S1912 of FIG. 19B, the aerosol generation device 200 defines interfaces and a driver based on the extender ID.

In process step S1913 of FIG. 19B, the aerosol generation device 200 executes an I2C Read process, described in relation to FIG. 20B. The process to read data from a specific extender then ends.

FIG. 19C is a flow chart illustrating the process to get a list of connected extenders executed in process step 1851 of FIG. 18F.

In process step 1921 of FIG. 19C, the aerosol generation device 200 gets a list of all possible I2C addresses of extenders.

In process step S1922 of FIG. 19D, the aerosol generation device 200 sets the value of a variable i equal to 0.

In process step S1923 of FIG. 19D, the aerosol generation device 200 sets the process to get a list of connected extenders to loop while i is less than the number of possible I2C addresses of extenders.

In process step S1924 of FIG. 19D, the aerosol generation device 200 performs a process to check device acknowledgement (ACK) on the I2C communication bus, as described in relation to FIG. 20C.

In process step S1925 of FIG. 19D, the aerosol generation device 200 determines whether an ACK has been received for an I2C address corresponding to the value of i.

In a case where an ACK has been received for the I2C address corresponding to the value of i, the process to get a list of connected extenders proceeds to process step S1926. Otherwise, the to get a list of connected extenders proceeds to process step S1927.

In process step S1926 of FIG. 19D, the aerosol generation device 200 adds an extender ID based on the I2C address corresponding to the value of i to the list of connected extenders.

In process step S1927 of FIG. 19D, the aerosol generation device 200 increments the value of i by one.

When the value of i becomes equal to the number of possible I2C addresses of extenders, the process to get a list of connected extenders proceeds to process step S1928. In process step S1928 of FIG. 19D, the aerosol generation device 200 returns the list of connected extenders.

FIGS. 20A to 20C are flow diagrams illustrating operations performed by the aerosol generation device 200 on the Hardware Abstraction Layer 1010 of the layer software architecture 1000 shown in FIG. 10.

FIG. 20A is a flow diagram illustrating the I2C Write process executed in process step S1903 of FIG. 19A.

In process step S2001 of FIG. 20A, the aerosol generation device 200 receives, as input to the I2C Write process, a device address, a register, data to write and a size of the data.

In process step S2002 of FIG. 20A, the aerosol generation device 200 performs an I2C hardware write sequence. The I2C Write process then ends.

FIG. 20B is a flow diagram illustrating the I2C Read process executed in process step S1913 of FIG. 19B.

In process step S2011 of FIG. 20B, the aerosol generation device 200 receives, as input to the I2C Write process, a device address, a register, a buffer for data and a size of the data.

In process step S2012 of FIG. 20B, the aerosol generation device 200 performs an I2C hardware read sequence. The I2C Read process then ends.

FIG. 20C is a flow diagram illustrating the process to check device acknowledgement (ACK) on the I2C communication bus executed in process step S1924 of FIG. 19C.

In process step S2021 of FIG. 20C, the aerosol generation device 200 receives, as an input to the process to check device acknowledgement (ACK) on the I2C communication bus, a device address and a number of trials.

In process step S2022 of FIG. 20C, the aerosol generation device 200 sets the value of a variable i equal to zero.

In process step S2023 of FIG. 20C, the aerosol generation device 200 sets the process to check device acknowledgement (ACK) on the I2C communication bus to loop while i is less than the number of trials.

In process step S2024 of FIG. 20C, the aerosol generation device 200 generates an I2C START condition.

In process step S2025 of FIG. 20C, the aerosol generation device 200 determines of the I2C STOPF flag is set.

If the I2C STOPF flag is set, the process to check device acknowledgement (ACK) on the I2C communication bus proceeds to process step S2027. Otherwise the process to check device acknowledgement (ACK) on the I2C communication bus proceeds to process step S2026.

In process step S2026 of FIG. 20C, the aerosol generation device 200 increments the value of i by one.

When the value of i becomes equal to the number of trials, the process to check device acknowledgement (ACK) on the I2C communication bus proceeds to process step S2027. In process step S2027 of FIG. 20C, the aerosol generation device 200 returns the result of the checking.

Furthermore, the following aspects are provided:

A1. An extension unit for an aerosol generation device, the extension unit comprising:
a first connection interface, at a first end of the extension unit, that is connectable to the aerosol generation device; and
means for enabling at least one additional functionality of the aerosol generation device, further to aerosol generation, when connected to the aerosol generation device.

A2. The extension unit of aspect A1, further comprising:
a second connection interface, at a second end of the extension unit opposite to the first end, that is connectable to a first other extension unit.

A3. The extension unit of aspect A2, wherein:
the first connection interface is further connectable to a second other extension unit; and
the second connection interface is further connectable to the aerosol generation device.

A4. The extension unit of aspect A2 or A3, wherein the first connection interface and/or the second connection interface comprises at least one of a magnetic connector, an interference fit connector, a plug connector, and a socket connector connectable to the aerosol generation device or the first other extension unit.

A5. The extension unit of any of aspects A2 to A4, wherein:
at least one of the first connection interface and the second connection interface comprises one or more data terminals and/or one or more power terminals, wherein preferably the first and second connection interfaces Include inter-integrated circuit, I2C, interfaces.

A6. The extension unit of any of aspects A1 to A5, wherein:
the extension unit is configured to receive power supplied from the aerosol generation device, when connected to the aerosol generation device.

A7. The extension unit of any of aspects A1 to A6, wherein:
the at least one additional functionality comprises a flashlight functionality; and the means for enabling the at least one additional functionality comprises at least one LED.

A8. The extension unit of aspect A7, wherein:
the at least one LED is configured to emit light and/or to blink or dim the emitted light in response to control signalling received from the aerosol generation device.

A9. The extension unit of any of aspects A1 to A8, wherein:
the at least one additional functionality comprises a haptic feedback functionality for indicating a status of the aerosol generation device; and the means for enabling the at least one additional functionality comprises at least one of an eccentric rotating mass, ERM, vibration motor and a linear resonant actuator, LRA, vibration motor to generate haptic feedback in the form of vibrations in response to control signalling received from the aerosol generation device.

A10. The extension unit of any of aspects A1 to A6, wherein:
the at least one additional functionality comprises a power supply functionality of supplying power to a connected device; and
the means for enabling the at least one additional functionality comprises at least one power supply.

A11. The extension unit of aspect A8, wherein:
the means for enabling at least one additional functionality further comprises a control section configured to control at least one of a magnitude and a direction of the supply of power.

A12. The extension unit of any of aspect A1 to A6, wherein:
the at least one additional functionality comprises a display functionality; and
the means for enabling the at least one additional functionality comprises at least one display unit configured to display information to a user of the aerosol generation device in response to control signalling received from the aerosol generation device.

A13. An aerosol generation device comprising a power supply unit, wherein the power supply unit comprises:
a power supply;
a control section; and
a connection interface that is connectable to an extension unit in accordance with any of aspects A1 to A12,
wherein the control section is configured to control at least one of a magnitude of power supply via the connection interface, a direction of power supply by the connection interface and transfer of data via the connection interface.

A14. The aerosol generation unit of aspect A13, wherein:
the connection interface comprises at least one of a magnetic connector, an interference fit connector, a plug connector, and a socket connector connectable to the extension unit; and/or the connection interface comprises one or more data terminals, and/or one or more power terminals, wherein preferably the connection interface includes an inter-integrated circuit, I2C, interface.

A15. A system comprising:
an aerosol generation device in accordance with aspect A13 or aspect A14; and
a first extension unit in accordance with any of aspects A1 to A14,
wherein the first extension unit is connected to the connection Interface of the power supply unit.

B1. A method of an aerosol generation device for controlling communication with one or more extension units via a communication bus, each of the one or more extension units being connectable to the aerosol generation device and configured to enable at least one additional functionality of the aerosol generation device, further to aerosol generation, when connected to the aerosol generation device, the method comprising:
identifying at least one communication address among a plurality of communication addresses of the communication bus for which signalling is received from an extension unit, among the one or more extension units, using the communication address;
associating, with each of the at least one communication address, an extension unit identifier indicating the extension unit from which the signalling was received;
determining, for each extension unit identifier, a current connection state of the extension unit indicated by the extension unit identifier; and controlling, for each extension unit identifier, communication with the extension unit indicated by the extension unit identifier via the communication bus using the communication address associated with the extension unit identifier and in accordance with the determined current connection state of the extension unit.

B2. The method according to aspect B1, further comprising:
determining, for each extension unit identifier, a type of the at least one additional functionality enabled by the extension unit indicated by the extension unit identifier,
wherein, for each extension unit identifier, communication with the extension unit indicated by the extension unit identifier is further controlled in accordance with the determined type of the at least one additional functionality enabled by the extension unit indicated by the extension unit identifier.

B3. The method according to aspect B2, further comprising:
determining a command to be sent to a first extension unit among the extension units indicated by the extension unit identifiers in accordance with the determined type of at least one additional functionality enabled by the first extension unit; and sending the command to the first extension unit via the communication bus using the communication address associated with the extension unit identifier indicating the first extension unit.

B4. The method according to aspect B2 or aspect B3, further comprising: for each extension unit identifier, in a case where the type of the at least one additional functionality enabled by the extension unit indicated by the extension unit identifier is a first type, periodically performing control to send a read command to the extension unit using the communication address associated with the extension unit identifier.

B5. The method according to aspect B4, wherein the control to send a read command to an extension unit is performed periodically in accordance with a predefined frequency associated with the extension unit or the type of the at least one additional functionality enabled by the extension unit.

B6. The method according to any of aspects B1 to B5, further comprising:
determining, for each extension unit identifier, a previous connection state of the extension unit indicated by the extension unit identifier; and
for each extension unit identifier, in a case where the previous connection state of the extension unit indicated by the extension unit identifier is not the same as current connection state of the extension unit, outputting a notification to the user of the aerosol generation device.

B7. The method according to aspect B6, further comprising:
for each extension unit identifier, in a case where the previous connection state of the extension unit indicated by the extension unit identifier is indicative of a non-connected state and the current connection state of the extension unit is indicative of a connected state, initializing the extension unit.

B8. The method according to any of aspects B1 to B7, further comprising:
receiving input from a user of the aerosol generation device via an input unit of the aerosol generation device;
determining a first extension unit identifier and an associated first communication address based on the received input;
determining a command to be sent to an extension unit indicated by the first extension unit identifier based on the received input; and
sending the command to the extension unit via the communication bus using the first communication address associated.

B9. The method according to any of aspects B1 to B8, further comprising:
receiving via the communication bus signalling from an extension unit among the one or more extension units indicative of input by a user of the aerosol generation device;
determining an extension unit identifier and an associated communication address of the extension unit;
determining a command to be sent to the extension unit based on the received signalling; and
sending the command to the extension unit via the communication bus using the determined communication address associated.

B10. The method according to any of aspects B1 to B9, wherein:
the communication bus is an inter-integrated circuit, I2C, communication bus;
the aerosol generation device functions as a master device; and each of the one or more extension units functions as a slave device.

B11. A computer program comprising instructions which, when executed by a control section of an aerosol generation device, cause the control section to perform the method of any of aspects B1 to B10.

B12. A power supply unit for an aerosol generation device, comprising a control section configured to perform a method according to any of aspects B1 to B10.

B13. An aerosol generation device comprising a power supply unit according to aspect B12.

It is noted that any of the above A aspects can be combined with any of the above B aspects.

Although detailed embodiments have been described, they only serve to provide a better understanding of the invention defined by the independent claims, and are not to be seen as limiting.

1. A method of an aerosol generation device for controlling communication with one or more extension units via a communication bus, each of the one or more extension units being connectable to the aerosol generation device and configured to enable at least one additional functionality of the aerosol generation device, further to aerosol generation, when connected to the aerosol generation device, the method comprising:
identifying at least one communication address among a plurality of communication addresses of the communication bus for which signalling is received from an extension unit, among the one or more extension units, using the communication address;
associating, with each of the at least one communication address, an extension unit identifier indicating the extension unit from which the signalling was received;
determining, for each extension unit identifier, a current connection state of the extension unit indicated by the extension unit identifier; and
controlling, for each extension unit identifier, communication with the extension unit indicated by the extension unit identifier via the communication bus using the communication address associated with the extension unit identifier and in accordance with the determined current connection state of the extension unit.

2. The method according to claim 1, further comprising:
determining, for each extension unit identifier, a type of the at least one additional functionality enabled by the extension unit indicated by the extension unit identifier,
wherein, for each extension unit identifier, communication with the extension unit indicated by the extension unit identifier is further controlled in accordance with the determined type of the at least one additional functionality enabled by the extension unit indicated by the extension unit identifier.

3. The method according to claim 2, further comprising:
determining a command to be sent to a first extension unit among the extension units indicated by the extension unit identifiers in accordance with the determined type of the at least one additional functionality enabled by the first extension unit; and
sending the command to the first extension unit via the communication bus using the communication address associated with the extension unit identifier indicating the first extension unit.

4. The method according to claim 2, further comprising:
for each extension unit identifier, in a case where the type of the at least one additional functionality enabled by the extension unit indicated by the extension unit identifier is a first type, periodically performing control to send a read command to the extension unit using the communication address associated with the extension unit identifier.

5. The method according to claim 4, wherein the control to send a read command to an extension unit is performed periodically in accordance with a predefined frequency associated with the extension unit or the type of the at least one additional functionality enabled by the extension unit.

6. The method according to claim 1, further comprising:
determining, for each extension unit identifier, a previous connection state of the extension unit indicated by the extension unit identifier; and
for each extension unit identifier, in a case where the previous connection state of the extension unit indicated by the extension unit identifier is not the same as current connection state of the extension unit, outputting a notification to a user of the aerosol generation device.

7. The method according to claim 6, further comprising:
for each extension unit identifier, in a case where the previous connection state of the extension unit indicated by the extension unit identifier is indicative of a non-connected state and the current connection state of the extension unit is indicative of a connected state, initializing the extension unit.

8. The method according to claim 1, further comprising:
receiving input from a user of the aerosol generation device via an input unit of the aerosol generation device;
determining a first extension unit identifier and an associated first communication address based on the received input;
determining a command to be sent to an extension unit indicated by the first extension unit identifier based on the received input; and
sending the command to the extension unit via the communication bus using the first communication address associated.

9. The method according to claim 1, further comprising:
receiving via the communication bus signalling from an extension unit among the one or more extension units indicative of input by a user of the aerosol generation device;
determining an extension unit identifier and an associated communication address of the extension unit;
determining a command to be sent to the extension unit based on the received signalling; and
sending the command to the extension unit via the communication bus using the determined associated communication address.

10. The method according to claim 1, wherein:
the communication bus is an inter-integrated circuit, I2C, communication bus;
the aerosol generation device functions as a master device; and
each of the one or more extension units functions as a slave device.

11. A computer program comprising instructions which, when executed by a control section of an aerosol generation device, cause the control section to perform the method of claim 1.

12. A power supply unit for an aerosol generation device, comprising a control section configured to perform a method according to claim 1.

13. An aerosol generation device comprising a power supply unit according to claim 12.
